(19) United States
(12) Patent Application Publication
(10) Pub. No.: US 2015/0237535 A1
(43) Pub. Date: Aug. 20, 2015

(54) MOBILE COMMUNICATION SYSTEM, FIRST BASE STATION, MOBILE STATION, AND COMMUNICATION METHOD FOR MOBILE COMMUNICATION SYSTEM

(71) Applicant: SHARP KABUSHIKI KAISHA, Osaka (JP)

(72) Inventor: Masafumi Aramoto, Osaka-shi (JP)

(73) Assignee: SHARP KABUSHIKI KAISHA, Osaka-shi, Osaka (JP)

(21) Appl. No.: 14/432,964

(22) PCT Filed: Oct. 1, 2013
(86) PCT No.: PCT/JP2013/076646

§ 371 Date: Apr. 1, 2015

(30) Foreign Application Priority Data
Oct. 2, 2012 (JP) 2012-220052

(51) Int. Cl. H04W 36/00; H04W 36/38; H04W 36/08

(52) U.S. Cl. CPC H04W 36/0022; H04W 36/08; H04W 36/38; H04W 88/08

(57) ABSTRACT

Provided is a mobile communication system in which a first base station included in a first access network initiatively performs a handover from the first base station to a second base station, the second base station determines the availability of the handover for each flow, and notifies the first base station of the determination result, the first base station transmits a flow for which the handover is determined to be possible to the second base station, and the second base station transmits the transmitted flow to a mobile station. Thus, in the handover of the mobile station in which data transmission is performed between the base stations in access systems, a handover destination access system determines a communication flow to be handed over and a communication flow to be handed over, and the switching and data transmission between the access networks are performed, based on the determination result.

### TECHNICAL FIELD

The present invention relates to a mobile communication system in which a first access network and a second access network are connected to a core network, a first base station included in the first access network initiatively hands over a mobile station connected to the first base station from the first base station to a second base station included in the second access network, with respect to communication of a plurality of flows.

### BACKGROUND ART

In the related art, various methods for performing a handover of a mobile station between different networks in a mobile communication system have been known.

As one of handover methods, there is a method in which a connected base station initiatively starts a handover procedure, while a mobile station does not initiatively perform the handover procedure.

Examples of the method include a handover from a Long Term Evolution (LTE) access network to a 3G access network, which are defined in the third generation partnership project (3GPP) specification, and a handover from the LTE access network to a 2G access network, in which the base station in the LTE access network connected to a mobile station generates a trigger and starts a handover procedure.

For example, NPL 1 defines mobile control (handover) in a mobile communication network in the related art. Thus, a mobile communication system in the related art will be descried with reference to FIG. 2 in which a base station connected to a mobile station initiatively performs a handover procedure. The mobile communication system of FIG. 2 is a type of the mobile communication system described in NPL 1.

In the mobile communication system of FIG. 2, a plurality of access networks (an access network A and an access network B) are connected to a core network. Further, user equipment (UE; mobile station) is connected to the core network through the access networks. The UE can be connected to the core network by being connected to either the access network A or the access network B.

Further, a packet data gateway (PGW: control station) transmitting communication data to the UE is provided in the core network. The PGW is connected through the access network A and the SGW.

Further, a mobility management entity (MME: management station) which is a management device configured to allow/disallow establishing a transfer path between the UE and the PGW is provided in the core network.

Here, the access network A is, for example, LTE defined in the 3GPP specification, and an eNB (LTE base station) connected to the UE is located in the access network. The UE and the eNB are connected to the core network through a serving GW (SGW).

Meanwhile, the access network B is, for example, a 3G or 2G network defined in the 3GPP specification, and a NB (3G base station or 2G base station) connected to the UE is located therein. The UE and the NB are connected to the core network through a gateway SGSN.

Further, in the core network, the SGSN and the SGW are connected, and the UE establishes a transfer path to the PGW through the NB, the SGSN, and the SGW. The establishment of the transfer path through the MME is managed during the establishment of the transfer path between the UE and the PGW.

Further, NPL 1 defines a handover procedure of continuing communication by switching to a state connected to the NB of the access network B from a state where the UE is connected to the eNB of the access network A and performs communication.

In such a handover procedure, the eNB located in the access network A starts the handover procedure. Thereafter, after checking that a NB in the access network B of a switching target, a SGSN, a SGW, and a PGW establish a switching target transfer path, the eNB notifies the UE of switching of the access network.

In other words, in the handover for switching the access network of the UE, the UE does not generate a trigger and initiatively perform the handover, but the base station initiatively starts the handover procedure and notifies the UE of the switching to perform the switching.

Further, a path for data transmission is established between the eNB located in the access network A and the NB located in the access network B, and the eNB that has received data prior to switching transmits the received data to the NB, from the start to the completion of the handover procedure.

Thus, before the handover is started, while the data which has been transmitted to the UE from the PGW is transmitted to the UE through the SGW and the eNB, during the handover procedure, the data which has been transmitted to the eNB from the PGW through the SGW is not transmitted to the UE but transmitted to the NB through the path for data transmission. The NB that has received the transmission data transmits the data to the UE.

If the handover procedure has been completed, the data transmission is stopped, and the data destined for the UE which has been transmitted from the PGW is transmitted to the UE through the SGW, the SGSN, and the NB.

In this manner, the data transmission is performed so as to avoid data loss until the handover procedure is completed and the transfer path is established.

Meanwhile, with respect to an explosion of data traffic volume due to a rapid increase of smartphones in recent years, using an access network such as WLAN has been attracting attention.

A mobile communication system accommodating an access network such as WLAN will be described with reference to FIG. 3. The mobile communication system in FIG. 3 is a type of the mobile communication system described in NPL 2.

In the mobile communication system of FIG. 3, a plurality of access networks (access network A and access network C) are connected to a core network. Further, a UE is connected to the core network through the access networks. The UE is connectable to the core network through either the access network A or the access network C, and connectable to both the access network A and the access network C at the same time, and it is possible to perform communication by selecting an access system, depending on the communication flow identified with an application and the like.

Here, the connection through the access network A is the same as the description that has been already made with reference to FIG. 2, and thus the description thereof will be omitted.

An access router (AR) connected to the UE is provided in the access network C, and the UE establishes a transfer path with a PGW in the core network through the AR and is connected to the core network.

Further, the 3GPP specification defines a handover procedure in which communication is continued by performing switching to the connection to the access network C, from a state where the UE is connected to the access network A.

Whereas the base station located in the access network A generates a trigger and performs the handover procedure in the handover for switching the access network from the access network A (LTE access network) to the access network B (3G access network) illustrated in FIG. 2, the UE generates a switching trigger and performs the handover procedure in the handover for switching the access network from the access network A (LTE access network) to the access network C (WLAN access network) illustrated in FIG. 3.

In other words, in a state where a transfer path with the PGW has been established through the eNB located in the access network A and the SGW, the UE itself generates a trigger, connects to an AR located in the access network B, establishes the transfer path with the PGW through the AR, and switches the communication that has been performed through the transfer path over the access network A to communication through the transfer path over the access network C, thereby continuing communication.

In such a handover procedure, it is possible to continue communication by switching all of the communications that have been performed through the transfer path over the access network A to communication through the transfer path over the access network C, and the switching can be performed in units of communication flows that are identified by an application and the like.

In a case of switching all of the communications, after the handover procedure has been completed, the transfer path established over the access network A is deleted.

Meanwhile, in a case of switching some of the flows, the UE can be connected to the access network A and the access network C at the same time, a state where the transfer path over the access network A and the transfer path over the access network C are established at the same time is maintained and the transfer path is separately used for each communication flow.

In this manner, the UE is connectable to different access systems such as the LTE access network, the 3G or 2G access network, and the WLAN access network.

However, in the handover procedure, there is a difference in which the base station determines the starting of the handover procedure in a case of performing a handover from the LTE access network to the 3G access network, whereas the UE determines the starting of the handover procedure in a case of performing a handover from the LTE access network to the WLAN access network.

### CITATION LIST

### Non Patent Literature

NPL 1: TS23.401 General Packet Radio Service (GPRS) enhancements for Evolved Universal Terrestrial Radio Access Network (E-UTRAN) access
NPL 2: TS23.402 Architecture enhancements for non-3GPP accesses

### SUMMARY OF INVENTION

### Technical Problem

In the mobile communication system (a packet communication system) in the related art defined in NPL 1, as illustrated in FIG. 2, the base station located in the access network can initiatively perform the handover of the mobile station, in which the access network is switched from the LTE access network to the 3G access network and communication is continued.

Further, in the mobile communication system (a packet communication system) in the related art defined in NPL 2, as illustrated in FIG. 3, the mobile station can initiatively perform the handover of the mobile station in which the access network is switched from the LTE access network to the WLAN access network and communication is continued.

With respect to the access network in the mobile communication system in which the base station initiatively performs the handover as described in NPL 1, it is assumed that the access network is switched from the LTE access network to the 2G or 3G access network, as already described.

Since an area of the LTE access network conforming to a new LTE specification for which standardization work is still on-going is smaller as compared to a large area for deploying the 2G and 3G access network, the handover procedure of switching the access network from the LTE access network to the 2G or 3G access network is useful because it can realize communication continuation of the mobile station, regardless of the location.

However, there is a big difference in the transmission capacity and the like in the communication specifications that have been extended to 2G, 3G, and LTE. Therefore, there is a possibility in that all of the communications performed by the mobile station over the LTE access network cannot be performed in the 3G access network which is a switching target.

A case is considered in which these cases are caused not only by the transmission capacity of the access network but also by the communication capacities of the switching target base station and a gateway device and the situation of the resources that another mobile station has already occupied.

In this manner, in the handover procedure for switching the communication that has been performed through the transfer path over the LTE access network to the communication through the transfer path over the 3G access network, if the communication resources for continuing the communication in the switching target cannot be secured, the handover procedure fails, and the communication is disconnected. In other words, the mobile station cannot continue the communication.

In other words, even though the mobile station can continue communication by switching the transfer path over the LTE access network to the transfer path over the WLAN access network as described in NPL 2, there is a problem in that it is not possible to continue the communication due to the communication disconnection.

Here, in the handover procedure for switching the communication that has been performed through the transfer path over the LTE access network to the communication through the transfer path over the 3G access network, a solution is considered in which the mobile station that has detected the communication disconnection is connected to the WLAN access network, when the communication is disconnected because the switching target resource cannot be secured.

However, in this solution, since the mobile station is finally connected only to the WLAN access network, the mobile station cannot be simultaneously connected to the 3G access network and the WLAN access network, and thus it is not possible to effectively utilize the respective communication resources.

Further, since the communication is once disconnected due to the handover failure and thereafter is newly connected to the WLAN access network, it takes a wasteful time to resume communication with the mobile station.

These problems are based on a fact in which the handover from the LTE access network to the 3G access network is initiatively performed by the base station, whereas the handover from the LTE access network to the WLAN access network is initiatively performed by the mobile station.

In other words, in the related art, when performing the handover from the LTE access network to the 3G access network, it is not possible to select the communication flow to be handed over depending on the state of the switching target resource and to switch some of the communication flows. Further, there is no means for notifying the mobile station that some of the flows are to be switched, and the mobile station cannot determine the starting of a handover to the WLAN access network.

Further, the base station that starts the handover procedure does not include means for detecting the resource state of the switching target base station, and thus the base station cannot transmit data to the switching target base station while selecting only switching-possible flows. Therefore, all of the communication flows that the UE performs communication are transmitted to the mobile destination base station, and thus a problem occurs in that the switching target base station cannot establish the transfer path to the UE due to lack of the resource, and cannot perform transmission.

In view of the above problems, an object of the present invention is to provide a mobile communication system in which in a handover of a mobile station in which data transmission is performed between the base stations in access systems, a handover destination access system determines a communication flow to be handed over and a communication flow to be handed over, and the switching and data transmission between the access networks are performed, based on the determination result.

### Solution to Problem

In order to solve the above problems, the present invention provides a mobile communication system in which a first access network and a second access network are connected to a core network, and a first base station included in the first access network initiatively performs a handover of a mobile station connected to the first base station, from the first base station to a second base station included in the second access network, with respect to communication including a plurality of flows,

in which the mobile station establishes a transfer path through a control station included in the core network and the first access network,

in which the second base station determines the availability of a handover for each flow, and notifies the first base station of the determined availability of handover,

in which the first base station establishes a transfer path to the second base station, and transmits a flow for which a handover is determined to be possible,

in which the second base station transmits the transmitted flow to the mobile station, and

in which the mobile station receives the transmitted flow from the second base station.

The present invention provides a first base station of a mobile communication system in which a first access network and a second access network are connected to a core network, and the first base station included in the first access network initiatively performs a handover of a mobile station connected to the first base station, from the first base station to a second base station included in the second access network, with respect to communication including a plurality of flows,

in which in a case of performing the handover of the mobile station establishing a transfer path through a control station included in the core network and the first access network, the first base station establishes a transfer path to the second base station, and transmits a flow for which a handover is determined to be possible, based on a determination result of the availability of a handover for each flow transmitted from the second base station.

The present invention provides a mobile station of a mobile communication system in which a first access network and a second access network are connected to a core network, a first base station included in the first access network initiatively performs a handover of a mobile station connected to the first base station, from the first base station to a second base station included in the second access network, with respect to communication including a plurality of flows,

in which the mobile station

establishes a transfer path through a control station included in the core network and the first access network, and

receives from the second base station, a flow for which a handover is determined to be possible, based on a determination result of the availability of a handover for each flow transmitted from the second base station, and which is transmitted from the first base station.

The present invention provides a communication method of a mobile communication system in which a first access network and a second access network are connected to a core network, and a first base station included in the first access network initiatively performs a handover of a mobile station connected to the first base station, from the first base station to a second base station included in the second access network, with respect to communication including a plurality of flows, the communication method comprising:

a step of establishing, by the mobile station, a transfer path through a control station included in the core network and the first access network,

a step of determining, by the second base station, an availability of a handover for each flow, and notify the first base station of the determined availability of handover,

a step of notifying, by the second base station, the first base station the mobile station of the determined availability of the handover;

a step of establishing, by the first base station, a transfer path to the second base station, and transmitting a flow for which the handover is determined to be possible,

a step of transmitting, by the second base station, the transmitted flow to the mobile station, and

a step of receiving, by the mobile station, the transmitted flow from the second base station.

### Advantageous Effects of Invention

According to the present invention, provided is a mobile communication system in which a first base station included in the first access network initiatively performs a handover of a mobile station connected to the first base station, from the first base station to a second base station included in the second access network, with respect to communication including a plurality of flows, the mobile station establishes a transfer path through a control station included in the core network and the first access network, the second base station determines an availability of a handover for each flow, and notifies the first base station and the mobile station of the determined availability of handover, the first base station establishes a transfer path to the second base station, and transmits a flow for which the handover is determined to be possible, the second base station transmits the transmitted flow to the mobile station, and the mobile station receives the transmitted flow from the second base station.

Accordingly, the first base station establishes a transfer path to the second base station, and transmits a flow for which a handover is determined to be possible, the second base station transmits the transmitted flow to the mobile station, and the mobile station receives the transmitted flow from the second base station. Thus, when the mobile station performs the handover, even if the handover is on-going, it is possible to receive the flow transmitted from the second base station.

### BRIEF DESCRIPTION OF DRAWINGS

FIG. 1 is a diagram illustrating an entire mobile communication system in the present embodiment.

FIG. 2 is a diagram illustrating a system in the related art.

FIG. 3 is a diagram illustrating a system in the related art.

FIG. 4 is a diagram illustrating a functional configuration of a UE in the present embodiment.

FIG. 5 is a diagram illustrating a functional configuration of a PGW in the present embodiment.

FIG. 6 is a diagram illustrating a functional configuration of a SGW in the present embodiment.

FIG. 7 is a diagram illustrating a functional configuration of a MME in the present embodiment.

FIG. 8 is a diagram illustrating a functional configuration of a SGSN in the present embodiment.

FIG. 9 is a diagram illustrating a functional configuration of an eNB in the present embodiment.

FIG. 10 is a diagram illustrating a functional configuration of a NB in the present embodiment.

FIG. 11 is a diagram illustrating a functional configuration of an AR in the present embodiment.

FIG. 12 is a diagram illustrating an example of a data structure of a UE flow management table in the present embodiment.

FIG. 13 is a diagram illustrating an example of a data structure of a PGW flow management table in the present embodiment.

FIG. 14 is a diagram illustrating an example of a data structure of a SGW flow management table in the present embodiment.

FIG. 15 is a diagram illustrating an example of a data structure of a MME flow management table in the present embodiment.

FIG. 16 is a diagram illustrating an example of a data structure of a SGSN flow management table in the present embodiment.

FIG. 17 is a diagram illustrating an example of a data structure of an eNB flow management table in the present embodiment.

FIG. 18 is a diagram illustrating an example of a data structure of a NB flow management table in the present embodiment.

FIG. 19 is a diagram illustrating an example of a data structure of an AR flow management table in the present embodiment.

FIG. 20 is a sequence diagram illustrating a handover procedure in the present embodiment.

FIG. 21 is a sequence diagram illustrating a switching procedure to WLAN in the present embodiment.

FIG. 22 is a diagram illustrating an operation flow of the NB in the present embodiment.

FIG. 23 is a diagram illustrating a process in the present embodiment.

### DESCRIPTION OF EMBODIMENTS

Hereinafter, the best mode for carrying out the present invention will be described with reference to the drawings. In addition, in the present embodiment, an embodiment of a mobile communication system to which the present invention is applied will be described in detail with reference to the drawings, as an example.

### 1. First Embodiment

First, a first embodiment will be described.

[1.1 Network Configuration]

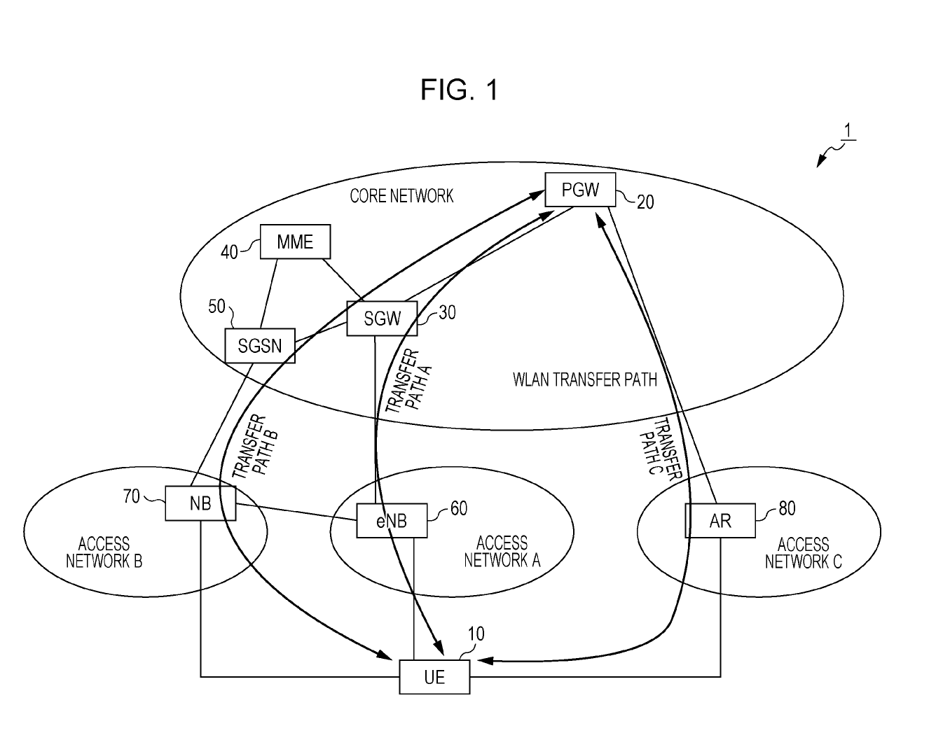

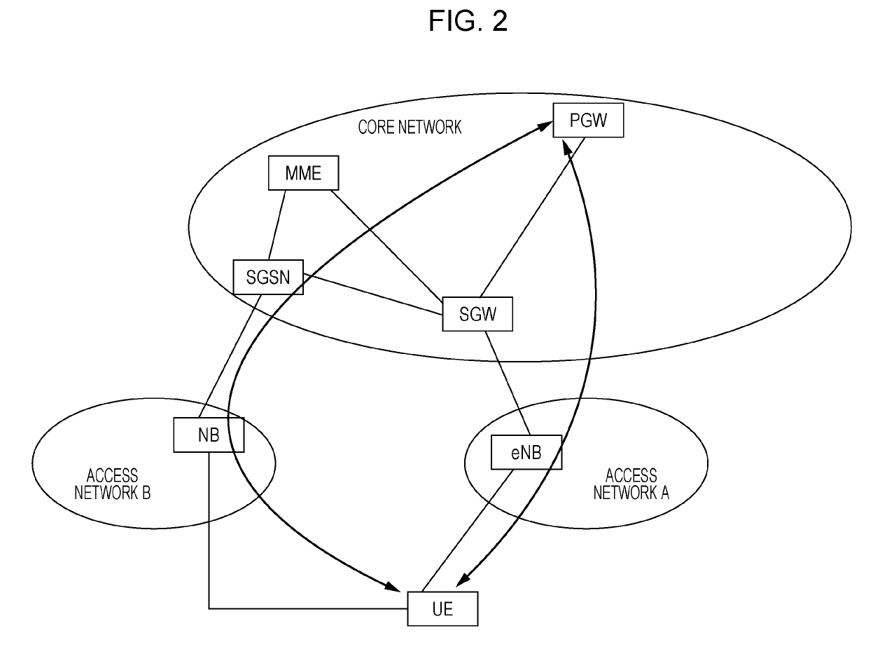

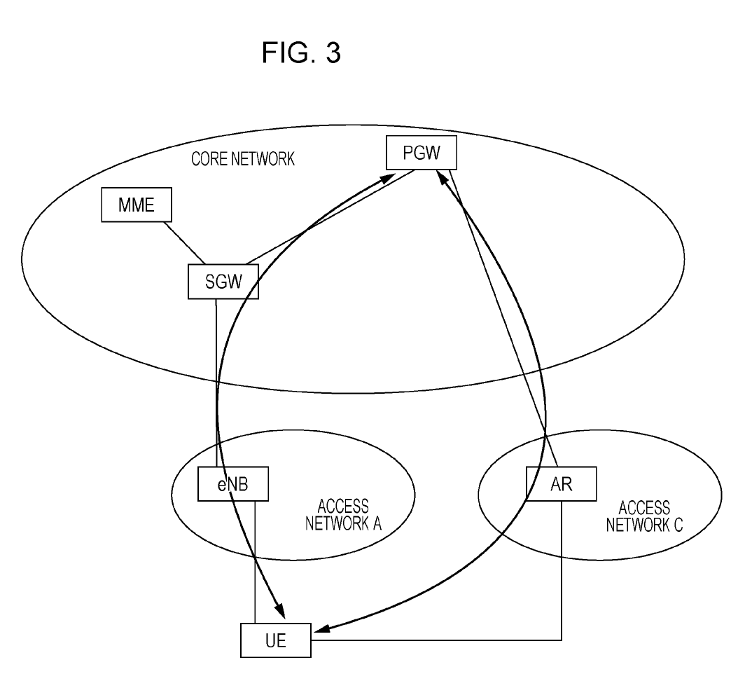

First, a network configuration in the present embodiment will be described with reference to FIG. 1. FIG. 1 is a diagram illustrating an outline of a mobile communication system 1 to which the present invention is applied. As illustrated in FIG. 1, in a mobile communication system 1, an access network A, an access network B, and an access network C are connected to a core network. Here, it is assumed that the access network A, the access network B, and the access network C are different networks, and for example, the access network A is an LTE access network of the 3GPP specification, the access network B is a 3G access network of the 3GPP specification, and the access network C is a non-3GPP network, for example, a WLAN access network.

First, a plurality of radio access networks are connected to the core network. The access network A includes an LTE base station (eNB 60) to which a UE 10 is connected, and is connected to the core network through the gateway (SGW 30).

A GW (PGW 20) is provided in the core network, the PGW 20 is a control station transmitting the communication data destined for the mobile station which has been transmitted from another mobile station, and is connected to the SGW 30. Further, a management device (MME 40) is provided in the core network, and the MME 40 receives a request for establishing a transfer path from the UE 10, and initiatively performs a procedure for establishing a transfer path between the UE 10 and the PGW 20 through the eNB 60 and the SGW 30. Here, the transfer path over the access network A is referred to as a transfer path A.

The access network B includes a 3G base station (NB 70) to which the UE 10 is connected, and is connected to the core network through a gateway (SGSN 50). In the core network, the SGSN 50 and the SGW 30 are connected, and the SGW 30 and the PGW 20 are connected. Further, the SGSN 30 is connected to the management device (MME 40) that manages the transfer path establishment between the UE 10 and the PGW 20 through the NB 70, the SGSN 60, and the SGW 30. Here, the transfer path over the access network is referred to as a transfer path B.

Further, the LTE base station (eNB 60) located in the access network A and the 3G base station (NB 70) located in the access network B are connected. Between the LTE base station (eNB 60) and the 3G base station (NB 70), a path for data transmission used during the handover procedure is provided.

An access router (AR 80) connected to the UE 10 is provided in the access network C, the UE 10 establishes a transfer path to the PGW in the core network through the AR 80 and connected to the core network. Here, the transfer path over the access network C is referred to as a transfer path C.

For example, the access network A is a Long Term Evolution (LTE) and the like which is a radio access network defined by the 3GPP which is a communication standard organization for a mobile telephone network, and the access network B is a 3G or 2G defined by the 3GPP. Further, the access network C is the access network such as a wireless LAN or WiMAX. Further, the core network is based on system architecture evolution (SAE) defined by the 3GPP described in NPL 1.

As described above, in the mobile communication system 1 using the packet communication in the present embodiment, the UE 10 can be connected to the core network through a plurality of access systems, and it is possible to perform the communication through each of the transfer paths.

[1.2 Configuration of Device]

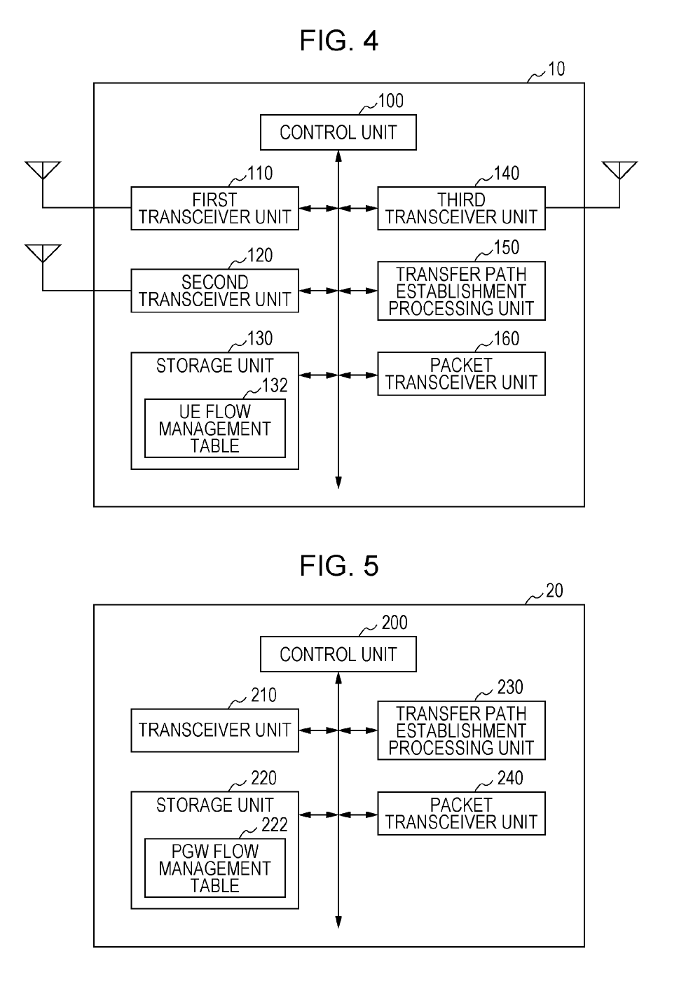

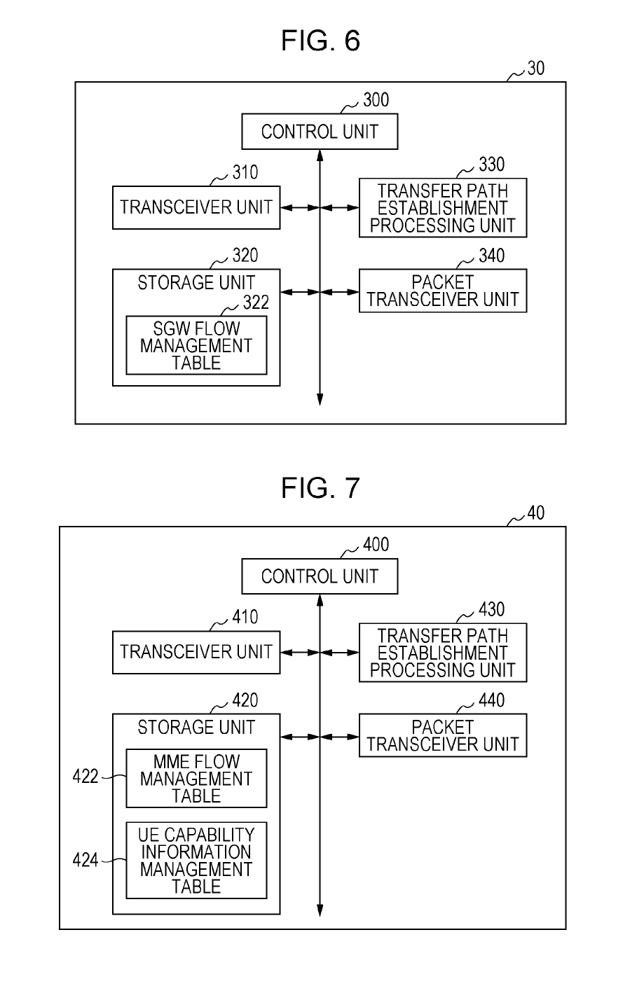

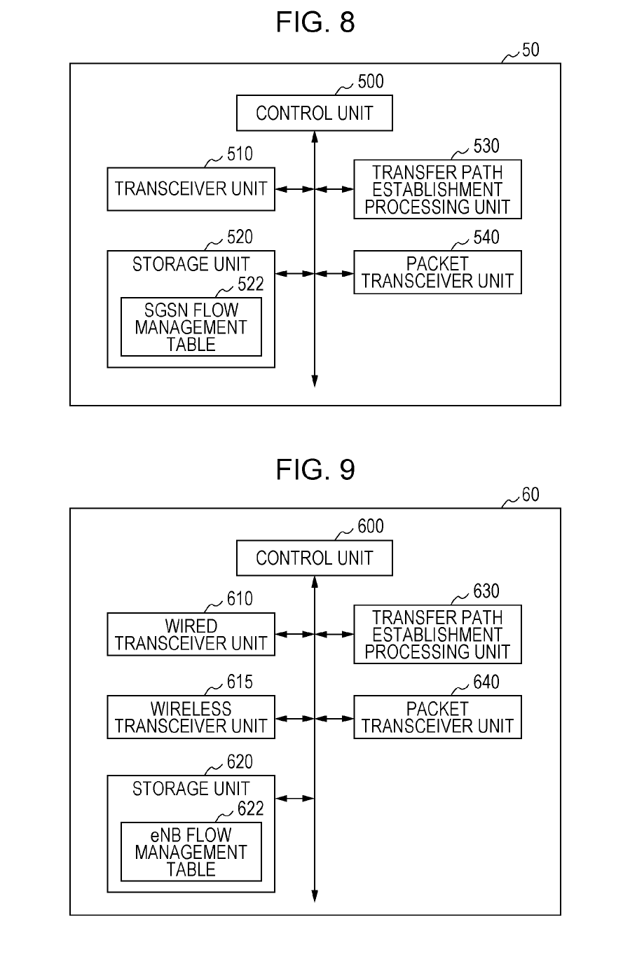

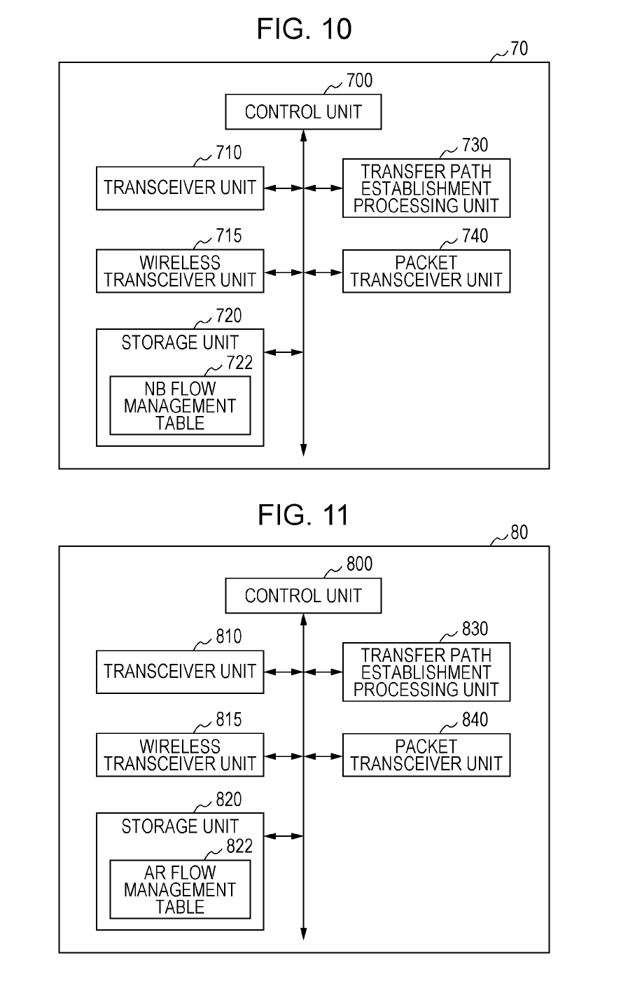

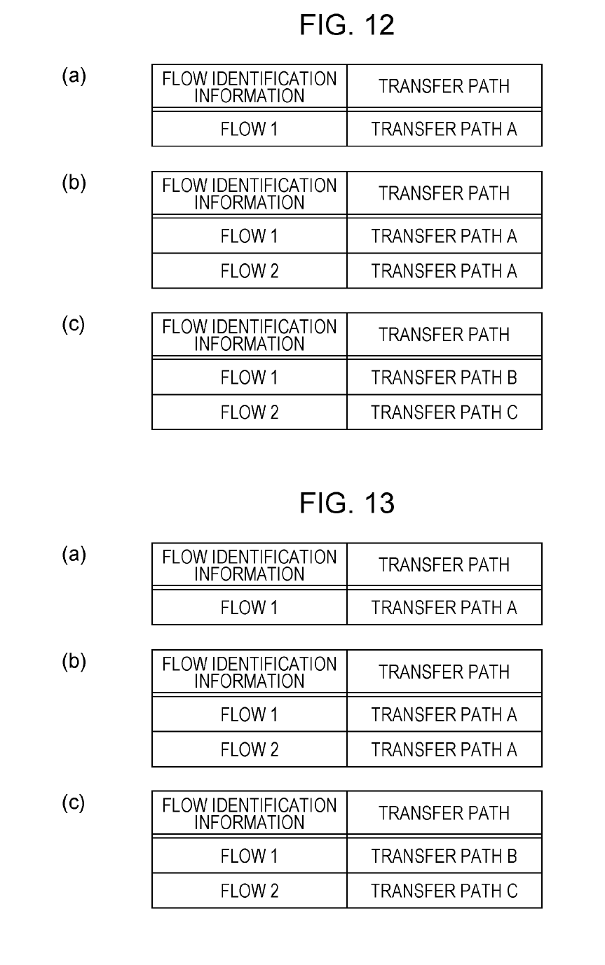

Subsequently, a brief description of the functional configuration of each device will be made with reference to the drawings. With respect to the functional configuration of each device, the configuration of the UE 10 is illustrated in FIG. 4, the configuration of the PGW 20 is illustrated in FIG. 5, the configuration of the SGW 30 is illustrated in FIG. 6, the configuration of the MME 40 is illustrated in FIG. 7, the configuration of the SGSN 50 is illustrated in FIG. 8, the configuration of the eNB 60 is illustrated in FIG. 9, the configuration of the NB 70 is illustrated in FIG. 10, and the configuration of the AR 80 is illustrated in FIG. 11.

[1.2.1 Configuration of UE]

First, the configuration of the UE 10 which is a mobile station will be described with reference to a block diagram of FIG. 4. Here, portable terminals that are simultaneously connected to the core network through a plurality of access networks, or a terminal such as a PDA are assumed as a specific example of the UE 10.

As illustrated in FIG. 4, the UE 10 is configured with a first transceiver unit 110, a second transceiver unit 120, a third transceiver unit 140, a storage unit 130, a transfer path establishment processing unit 150, and a packet transceiver unit 160 which are connected to a control unit 100.

The control unit 100 is a functional unit for controlling the UE 10. The control unit 100 realizes respective processes by reading and executing various programs stored in the storage unit 130.

The first transceiver unit 110, the second transceiver unit 120, and the third transceiver unit 140 are functional units that the UE 10 uses for connection to respective access networks. The first transceiver unit 110 is a functional unit for connection to the access network A, the second transceiver unit 120 is a functional unit for connection to the access network B, and the third transceiver unit 140 is a functional unit for connection to the access network C. External antennas are connected to the first transceiver unit 110, the second transceiver unit 120, and the third transceiver unit 140.

The storage unit 130 is a functional unit storing programs necessary for the various operations of the UE 10, data, and the like. Further, the storage unit 130 stores a UE flow management table 132 that stores flow identification information for identifying an application and a transfer path for transmission in association with each other. When the packet transceiver unit 160 transmits data, the transfer path for each flow is selected with reference to the UE flow management table 132, and the data is transmitted from the transceiver unit corresponding to the transfer path.

Here, FIG. 12 illustrates an example of a data configuration of the UE flow management table 132. As illustrated in FIG. 12(a), the UE flow management table 132 stores flow identification information (for example, “flow 1”) and a transfer path (for example, “transfer path A”) in association with each other.

The flow identification information is information enabling the identification of a plurality of communication flows that the UE 10 communicates, and performs the identification by using, for example, a traffic flow template (TFT). The TFT is an identification information group including an IP address, a port number, a protocol number, a domain name of a connection destination, application identification information, and the like, for example, the “flow 1” can be identified by the TFT among a plurality of communication flows that the UE 10 communicates.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

The transfer path establishment processing unit 150 is a functional unit that performs a process for establishing transfer paths (transfer path A, transfer path B, and transfer path C) to the PGW 20 over respective access networks of the access network A, the access network B, and the access network C.

Further, the packet transceiver unit 160 is a functional unit that transmits and receives specific data (packet). The data received from a higher layer is decomposed into packets and transmits the packets. Further, a function of passing the received packets to the higher layer is realized.

[1.2.2 Configuration of PGW]

Next, the configuration of the PGW 20 in the present embodiment will be described based on FIG. 5. The PGW 20 includes a transceiver unit 210, a storage unit 220, a transfer path establishment processing unit 230, and a packet transceiver unit 240 which are connected to a control unit 200.

The control unit 200 is a functional unit for controlling the PGW 20. The control unit 200 realizes respective processes by reading and executing various programs stored in the storage unit 220.

The transceiver unit 210 is a functional unit that is wired to a router or a switch, and performs transmission and reception of a packet. For example, the packet is transmitted and received by the Ethernet (registered trademark) or the like which is generally used as a connection system of a network.

The storage unit 220 is a functional unit storing programs necessary for the various operations of the PGW 20, data, and the like. Further, the storage unit 220 stores a PGW flow management table 222 that associates and stores flow identification information for identifying an application communicated by the UE 10 and a transfer path for each UE 10. When the packet transceiver unit 240 transmits data, the transfer path for each flow is selected with reference to the PGW flow management table 222, and the data is transmitted from the transceiver unit corresponding to the transfer path.

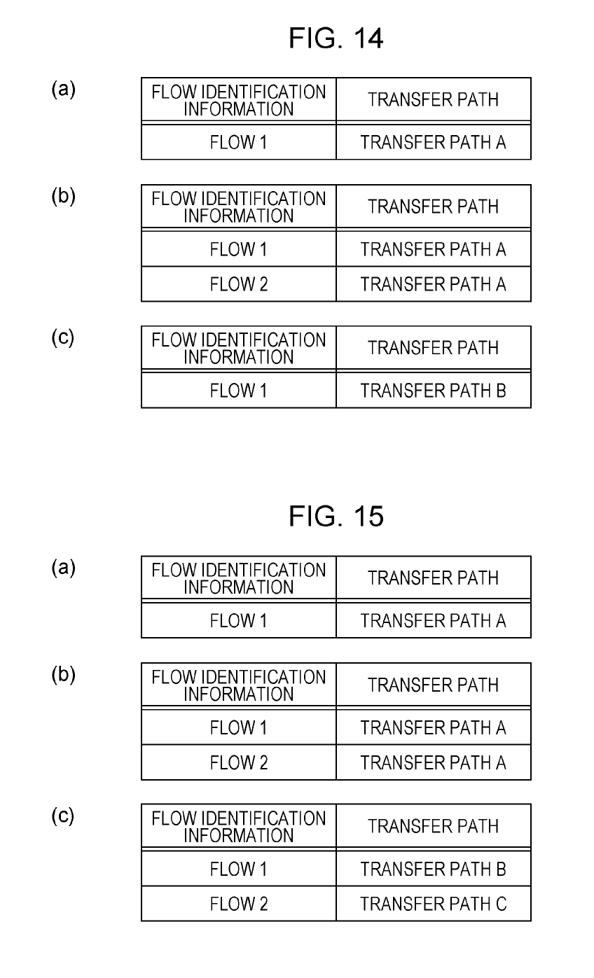

Here, FIG. 13 illustrates an example of a data configuration of the PGW flow management table 222. As illustrated in FIG. 13(a), the PGW flow management table 222 stores flow identification information (for example, “flow 1”) and a transfer path (for example, “transfer path A”) in association with each other.

The flow identification information is information enabling the identification of a plurality of communication flows that the UE 10 communicates, and performs the identification by using, for example, a traffic flow template (TFT). The TFT is an identification information group including an IP address, a port number, a protocol number, a domain name of a connection destination, application identification information, and the like, and for example, the “flow 1” can be identified by the TFT among a plurality of communication flows that the UE 10 communicates.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

The transfer path establishment processing unit 230 is a functional unit that performs a process for establishing transfer paths to the PGW 20 over respective access networks of the access network A, the access network B, and the access network C.

Further, the packet transceiver unit 240 is a functional unit that transmits and receives specific data (packet).

[1.2.3 Configuration of SGW]

Next, the configuration of the SGW 30 in the present embodiment will be described based on FIG. 6. The SGW 30 includes a transceiver unit 310, a storage unit 320, a transfer path establishment processing unit 330, and a packet transceiver unit 340 which are connected to a control unit 300.

The control unit 300 is a functional unit for controlling the SGW 30. The control unit 300 realizes respective processes by reading and executing various programs stored in the storage unit 320.

The transceiver unit 310 is a functional unit that is wired to a router or a switch, and performs transmission and reception of a packet. For example, the packet is transmitted and received by the Ethernet (registered trademark) or the like which is generally used as a connection system of a network.

The storage unit 320 is a functional unit storing programs necessary for the various operations of the SGW 30, data, and the like. Further, the storage unit 320 stores a SGW flow management table 322 that associates and stores flow identification information for identifying an application communicated by the UE 10 and a transfer path for each UE 10. When the packet transceiver unit 340 transmits data, the transfer path for each flow is selected with reference to the SGW flow management table 322, and the data is transmitted from the transceiver unit corresponding to the transfer path.

Here, FIG. 14 illustrates an example of a data configuration of the SGW flow management table 322. As illustrated in FIG. 14(a), the SGW flow management table 322 stores flow identification information (for example, “flow 1”) and a transfer path (for example, “transfer path A”) in association with each other.

The flow identification information is information enabling the identification of a plurality of communication flows that the UE 10 communicates, and performs the identification by using, for example, a traffic flow template (TFT). The TFT is an identification information group including an IP address, a port number, a protocol number, a domain name of a connection destination, application identification information, and the like, and for example, the “flow 1” can be identified by the TFT among a plurality of communication flows that the UE 10 communicates.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

The transfer path establishment processing unit 330 is a functional unit that performs a process for establishing transfer paths to the PGW 20 over respective access networks of the access network A, the access network B, and the access network C.

Further, the packet transceiver unit 340 is a functional unit that transmits and receives specific data (packet).

[1.2.4 Configuration of MME]

Next, the configuration of the MME 40 in the present embodiment will be described based on FIG. 7. The MME 40 includes a transceiver unit 410, a storage unit 420, a transfer path establishment processing unit 430, and a packet transceiver unit 440 which are connected to a control unit 400.

The control unit 400 is a functional unit for controlling the MME 40. The control unit 400 realizes respective processes by reading and executing various programs stored in the storage unit 420.

The transceiver unit 410 is a functional unit that is wired to a router or a switch, and performs transmission and reception of a packet. For example, the packet is transmitted and received by the Ethernet (registered trademark) or the like which is generally used as a connection system of a network.

The storage unit 420 is a functional unit storing programs necessary for the various operations of the MME 0, data, and the like. Further, the storage unit 420 stores a MME flow management table 422 that associates and stores flow identification information for identifying an application communicated by the UE 10 and a transfer path for each UE 10. When the packet transceiver unit 440 transmits data, the transfer path for each flow is selected with reference to the MME flow management table 422, and the data is transmitted from the transceiver unit corresponding to the transfer path.

The flow identification information is information enabling the identification of a plurality of communication flows that the UE 10 communicates, and performs the identification by using, for example, a traffic flow template (TFT). The TFT is an identification information group including an IP address, a port number, a protocol number, a domain name of a connection destination, application identification information, and the like, and for example, the “flow 1” can be identified by the TFT among a plurality of communication flows that the UE 10 communicates.

Here, FIG. 15 illustrates an example of a data configuration of the MME flow management table 422. As illustrated in FIG. 15(a), the MME flow management table 422 stores flow identification information (for example, “flow 1”) and a transfer path (for example, “transfer path A”) in association with each other.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

Further, the MME 40 stores a UE capability information management table 424 in the storage unit 420. When the UE 10 performs a handover from the access network A to the access network B, unlike the handover in the related art, the capability information indicating that the UE can perform the handover of some communication flows by using the resource of the access network B or the UE can switch a communication flow that could not be switched to the access network B, to the access network C is managed in the UE capability information management table 424. The UE capability information management table 424 manages, for example, a list of UEs having the capabilities.

Specific examples of the capability information include information regarding the connection availability of an access network, information regarding the connection availability by a service, or information regarding the connection availability by the user. Further, even if connection is possible, information regarding whether or not a handover is to be performed for each communication flow may be included, depending on a network status, a service status, the setting by the user, and the like.

The transfer path establishment processing unit 430 is a functional unit that performs a process for establishing transfer paths to the PGW 20 over respective access networks of the access network A, the access network B, and the access network C.

Further, the packet transceiver unit 440 is a functional unit that transmits and receives specific data (packet).

[1.2.5 Configuration of SGSN]

Next, the configuration of the SGSN 50 in the present embodiment will be described based on FIG. 8. The SGSN 50 includes a transceiver unit 510, a storage unit 520, a transfer path establishment processing unit 530, and a packet transceiver unit 540 which are connected to a control unit 500.

The control unit 500 is a functional unit for controlling the SGSN 50. The control unit 500 realizes respective processes by reading and executing various programs stored in the storage unit 520.

The transceiver unit 510 is a functional unit that is wired to a router or a switch, and performs transmission and reception of a packet. For example, the packet is transmitted and received by the Ethernet (registered trademark) or the like which is generally used as a connection system of a network.

The storage unit 520 is a functional unit storing programs necessary for the various operations of the SGSN 50, data, and the like. Further, the storage unit 520 stores a SGSN flow management table 522 that stores flow identification information for identifying an application communicated by the UE 10 for each UE 10. When the packet transceiver unit 540 transmits data, the transfer path for each flow is selected with reference to the SGSN flow management table 522, and the data is transmitted from the transceiver unit corresponding to the transfer path.

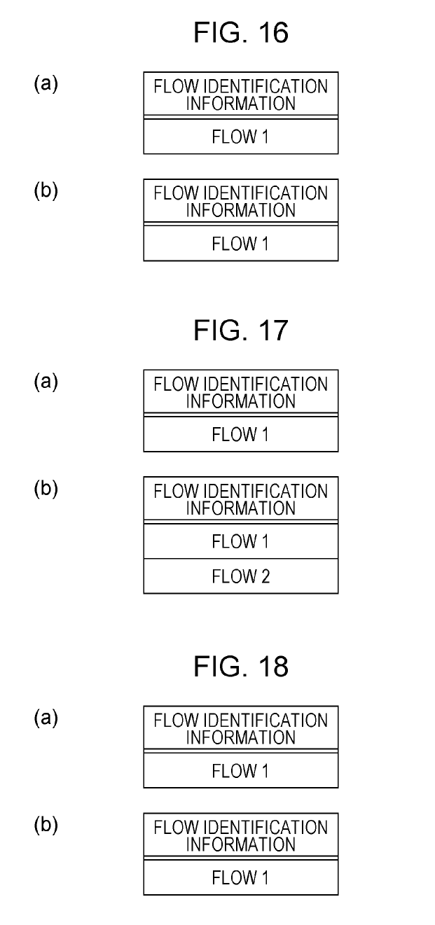

Here, FIG. 16 illustrates an example of a data configuration of the SGSN flow management table 522. As illustrated in FIG. 16(a), the SGSN flow management table 522 stores flow identification information (for example, “flow 1”).

The flow identification information is information enabling the identification of a plurality of communication flows that the UE 10 communicates, and performs the identification by using, for example, a traffic flow template (TFT). The TFT is an identification information group including an IP address, a port number, a protocol number, a domain name of a connection destination, application identification information, and the like, and for example, the “flow 1” can be identified by the TFT among a plurality of communication flows that the UE 10 communicates.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

The transfer path establishment processing unit 530 is a functional unit that performs a process for establishing a transfer path between the UE 10 and the PGW 20 over the access network B.

Further, the packet transceiver unit 540 is a functional unit that transmits and receives specific data (packet).

[1.2.6 Configuration of eNB]

Next, the configuration of the eNB 60 in the present embodiment will be described based on FIG. 9. The eNB 60 includes a wired transceiver unit 610, a wireless transceiver unit 615, a storage unit 620, a transfer path establishment processing unit 630, and a packet transceiver unit 640 which are connected to a control unit 600.

The control unit 600 is a functional unit for controlling the eNB 60. The control unit 600 realizes respective processes by reading and executing various programs stored in the storage unit 620.

The wired transceiver unit 610 is a functional unit that is wired to a router or a switch, and performs transmission and reception of a packet to and from the SGW 30. For example, the packet is transmitted and received by the Ethernet (registered trademark) or the like which is generally used as a connection system of a network.

Further, the wired reception unit 610 performs the data transmission and reception with the SGW 30, as well as the data transmission and reception with the NB 70 located in the access network B. Specifically, during the handover procedure of the UE 10, the transmission and reception data of the UE 10 is transmitted to the NB 70.

An antenna is connected to the wireless transceiver unit 615, and the wireless transceiver unit 615 is a functional unit that performs transmission and reception of a packet to and from the UE 10. The wireless transceiver unit 615 performs the transmission and reception by the LTE access system defined by the 3GPP.

The storage unit 620 is a functional unit storing programs necessary for the various operations of the eNB 60, data, and the like. Further, the storage unit 620 stores an eNB flow management table 622 that stores flow identification information for identifying an application that the UE 10 performs communication through the transfer path A over the access network A, for each UE 10.

Here, FIG. 17 illustrates an example of a data configuration of the eNB flow management table 622. As illustrated in FIG. 17(a), the eNB flow management table 622 stores flow identification information (for example, “flow 1”).

The flow identification information is information enabling the identification of a plurality of communication flows that the UE 10 communicates, and performs the identification by using, for example, a traffic flow template (TFT). The TFT is an identification information group including an IP address, a port number, a protocol number, a domain name of a connection destination, application identification information, and the like, and for example, the “flow 1” can be identified by the TFT among a plurality of communication flows that the UE 10 communicates.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

The transfer path establishment processing unit 630 is a functional unit that performs a process for establishing a transfer path to the PGW 20 over the access network A.

Further, the packet transceiver unit 640 is a functional unit that transmits and receives specific data (packet).

[1.2.7 Configuration of NB]

Next, the configuration of the NB 70 in the present embodiment will be described based on FIG. 10. The NB 70 includes a wired transceiver unit 710, a wireless transceiver unit 715, a storage unit 720, a transfer path establishment processing unit 730, and a packet transceiver unit 740 which are connected to a control unit 700.

The control unit 700 is a functional unit for controlling the NB 70. The control unit 700 realizes respective processes by reading and executing various programs stored in the storage unit 720.

The wired transceiver unit 710 is a functional unit that is wired to a router or a switch, and performs transmission and reception of a packet to and from the SGSN 50. For example, the packet is transmitted and received by the Ethernet (registered trademark) or the like which is generally used as a connection system of a network.

Further, the wired reception unit 710 performs the data transmission and reception with the SGSN 50, as well as the data transmission and reception with the eNB 60 located in the access network A. Specifically, during the handover procedure of the UE 10, the transmission and reception data of the UE 10 is transmitted from the eNB 60.

An antenna is connected to the wireless transceiver unit 715, and the wireless transceiver unit 715 is a functional unit that performs transmission and reception of a packet to and from the UE 10. The wireless transceiver unit 715 performs the transmission and reception by the 3G access system or the 2G access system defined by the 3GPP.

The storage unit 720 is a functional unit storing programs necessary for the various operations of the NB 70, data, and the like. Further, the storage unit 720 stores a NB flow management table 722 that stores flow identification information for identifying an application that the UE 10 performs communication through the transfer path B over the access network B, for each UE 10.

Here, FIG. 18 illustrates an example of a data configuration of the NB flow management table 722. As illustrated in FIG. 18(a), the NB flow management table 722 stores flow identification information (for example, “flow 1”).

The flow identification information is information enabling the identification of a plurality of communication flows that the UE 10 communicates, and performs the identification by using, for example, a traffic flow template (TFT). The TFT is an identification information group including an IP address, a port number, a protocol number, a domain name of a connection destination, application identification information, and the like, and for example, the “flow 1” can be identified by the TFT among a plurality of communication flows that the UE 10 communicates.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

The transfer path establishment processing unit 730 is a functional unit that performs a process for establishing a transfer path to the PGW 20 over the access network B.

Further, the packet transceiver unit 740 is a functional unit that transmits and receives specific data (packet).

[1.2.8 Configuration of AR]

Next, the configuration of the AR 80 in the present embodiment will be described based on FIG. 11. The AR 80 includes a wired transceiver unit 810, a wireless transceiver unit 815, a storage unit 820, a transfer path establishment processing unit 830, and a packet transceiver unit 840 which are connected to a control unit 800.

The control unit 800 is a functional unit for controlling the AR 80. The control unit 800 realizes respective processes by reading and executing various programs stored in the storage unit 820.

The wired transceiver unit 810 is a functional unit that is wired to a router or a switch, and performs transmission and reception of a packet to and from the PGW 20. For example, the packet is transmitted and received by the Ethernet (registered trademark) or the like which is generally used as a connection system of a network.

An antenna is connected to the wireless transceiver unit 815, and the wireless transceiver unit 815 is a functional unit that performs transmission and reception of a packet to and from the UE 10. The wireless transceiver unit 815 performs the transmission and reception by the WLAN access system.

The storage unit 820 is a functional unit storing programs necessary for the various operations of the AR 80, data, and the like. Further, the storage unit 820 stores an AR flow management table 822 that stores flow identification information for identifying an application that the UE 10 performs communication through the transfer path C over the access network C, for each UE 10.

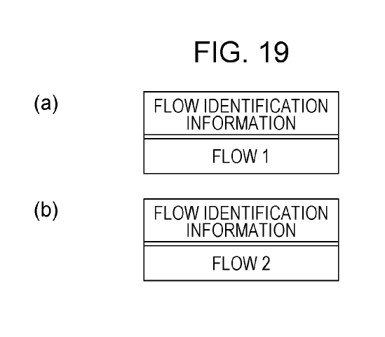

Here, FIG. 19 illustrates an example of a data configuration of the AR flow management table 822. As illustrated in FIG. 19(a), the AR flow management table 822 stores flow identification information (for example, “flow 1”).

The flow identification information is information enabling the identification of a plurality of communication flows that the UE 10 communicates, and performs the identification by using, for example, a traffic flow template (TFT). The TFT is an identification information group including an IP address, a port number, a protocol number, a domain name of a connection destination, application identification information, and the like, and for example, the “flow 1” can be identified by the TFT among a plurality of communication flows that the UE 10 communicates.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

The transfer path establishment processing unit 830 is a functional unit that performs a process for establishing a transfer path to the PGW 20 over the access network C.

Further, the packet transceiver unit 840 is a functional unit that transmits and receives specific data (packet).

[1.3 Initial State in the Present Embodiment]

Next, the initial state of the present embodiment will be described. In FIG. 1, the UE 10 is connected to the access network A and performs the communication of a plurality of communication flows.

Here, the access network A is the LTE access network, the UE 10 is connected to the eNB 60 which is the LTE base station, and establishes a transfer path to the PGW 20 through the eNB 60 and the SGW 30.

Hereinafter, a description will be made regarding an example in which the UE 10 performs communication of two flows of a “flow 1” and a “flow 2”, as a specific example.

The UE 10 manages the flow identification information and the transfer path in association with each other in the UE flow management table 132. For example, as illustrated in FIG. 12(b), the flow identification information of the “flow 1” and the “transfer path A” over the access network A are managed, and the flow identification information of the “flow 2” and the “transfer path A” over the access network A are managed.

The PGW 20 manages the flow identification information and the transfer path in association with each other in the PGW flow management table 222. For example, as illustrated in FIG. 13(b), the flow identification information of the “flow 1” and the “transfer path A” over the access network A are managed, and the flow identification information of the “flow 2” and the “transfer path A” over the access network A are managed.

The SGW 30 manages the flow identification information and the transfer path in association with each other in the SGW flow management table 322. For example, as illustrated in FIG. 14(b), the flow identification information of the “flow 1” and the “transfer path A” over the access network A are managed, and the flow identification information of the “flow 2” and the “transfer path A” over the access network A are managed.

The MME 40 manages the flow identification information and the transfer path in association with each other in the MME flow management table 422. For example, as illustrated in FIG. 15(b), the flow identification information of the “flow 1” and the “transfer path A” over the access network A are managed, and the flow identification information of the “flow 2” and the “transfer path A” over the access network A are managed.

The eNB 60 manages the flow identification information that the UE 10 performs communication through the transfer path over the access network A, in the eNB flow management table 622. For example, as illustrated in FIG. 17(b), the flow identification information of the “flow 1” and the flow identification information of the “flow 2” are managed.

Further, when the UE 10 performs a handover from the access network A to the access network B, unlike the handover in the related art, the MME 40 manages the capability information indicating that the UE can perform the handover of some communication flows by using the resource of the access network B or the UE can switch a communication flow that could not be switched to the access network B, to the access network C, in the UE capability information management table 424.

In an attach procedure when the UE 10 is initially connected to the core network over the access network A, the UE 10 notifies the MME 40 of the UE capability information, and thus the MME 40 registers the UE capability information in the UE capability information management table 424.

Otherwise, the network operator has acquired subscriber information, the UE 10 and the capability information, and may register the acquired information in the UE capability information management table 424 in the MME 40, based on the subscriber information.

As described above, in the initial state of the present embodiment, the UE 10 is connected to the core network over the access network A, establishes a transfer path between the UE 10 and PGW 20, and performs the communication of a plurality of communication flows.

[1.4 Handover Procedure]

Subsequently, a description will be made regarding a handover procedure of the present embodiment. In the handover procedure of the present embodiment, a procedure of performing a handover of communication flows that are communicated from the transfer path over the access network A to the transfer path over the access network B is started, and whether the handover is not possible in part is detected depending on the status of the resource of the access network B in the handover procedure.

Further, handover-possible flow and handover-impossible flow are distinguished and determined, and the handover-possible flow is subjected to a handover to the access network B and communication is continued.

Further, the UE 10 is notified of the presence of the handover-impossible flow and flow identification information for identifying the handover-impossible flow.

The UE 10 that has received notification establishes a transfer path over the access network C, and continues communication by switching the flow that is not possible to continue the communication through the transfer path over the access network B to the flow through the transfer path over the access network C.

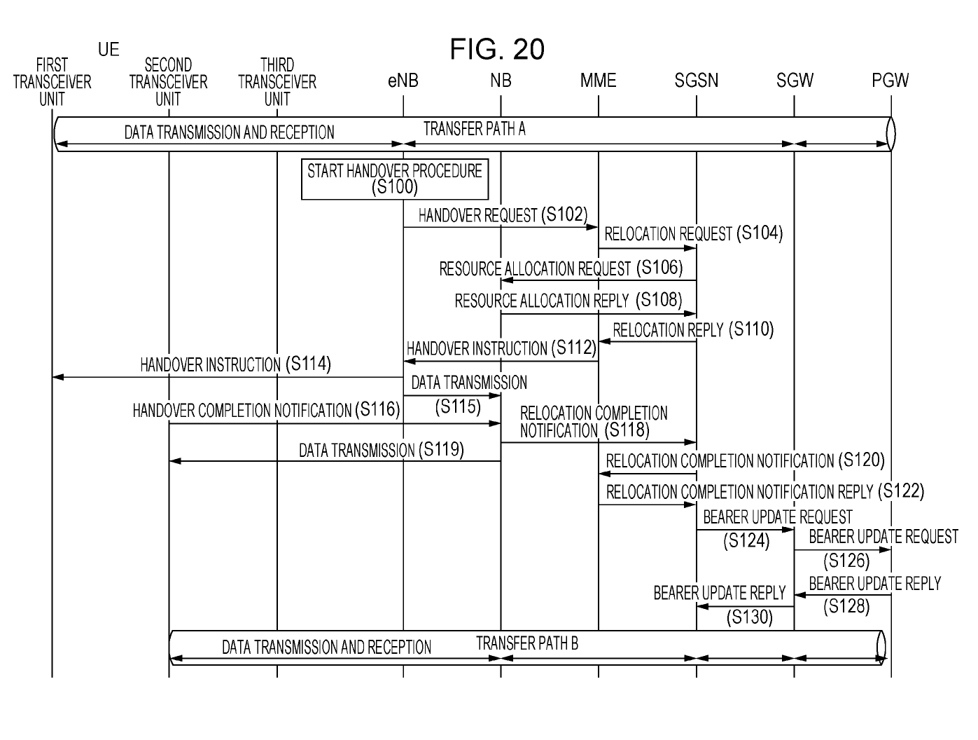

A specific handover procedure will be described with reference to FIG. 20. The UE 10 is connected to the core network over the access network A which is an LTE access network, through the first transceiver unit having a capability of being connected to the LTE access system. The LIE 10 establishes a transfer path with the PGW 20 over the access network A through the eNB 80 and the SGW 30, and performs communication of a plurality of flows (for example “flow 1” and “flow 2”).

(1) The eNB 60 in the access network A that is connected by the UE 10 determines the UE 10 to start a handover procedure to the transfer path over the access network B (S100). The handover procedure can be started based on information regarding adjacent base stations that the UE 10 periodically transmits. Further, when determining the starting of the handover procedure, the eNB 60 can specify a base station of a handover destination. In the present embodiment, the base station of a handover destination is detected as the NB 70 located in the access network B different form the access network A.

(2) The eNB 60 transmits a handover request to the MME 40, and starts the handover procedure (S102). The handover request message is transmitted by including the identification information regarding the UE 10 and the identification information regarding the NB 70 of a handover destination.

(3) The MME 40 receives the handover request, and determines whether to permit a handover of the UE 10 from the transfer path over the access network A to the transfer path over the access network B; and when the handover is permitted, the MME 40 transmits a relocation request to the SGSN 50 located in the access network B (S104). The relocation request is transmitted by including the identification information regarding the UE 10 and the identification information regarding the switching target NB 70.

The MME 10 makes a request for switching to the access network B of the handover destination in response to the relocation request, and inquires whether resources can be secured in the access network B. Therefore, the MME 10 transmits the relocation request message by including information for calculating a resource which is required for the UE 10 to continue communication such as the identification information regarding a flow being communicated by the UE 10 and QoS information regarding the flow.

Here, when the MME 40 transmits the relocation request, the MME 40 checks the presence or absence of the capability of the UE 10, with reference to the UE capability information management table 424.

Further, differently from the related art, when it is checked that the UE 10 has the capability based on the UE capability information management table 424, the MME 40 transmits the relocation request by assigning a flag (hereinafter, referred to as a “some-flow switching flag”) indicating the handover for allowing some-flow switching depending on the switching target resource, which is described in the present embodiment and different from the related art.

Regardless of the relocation request message, the “some-flow switching flag” is assigned in the control message, because when sufficient resources of a handover destination access network are not secured and only some of the flows are not switched, the handover of all of the flows is not rejected as in the related handover, the flow for which the resource can be secured is handed over, and after determination, the notification of the flow for which the resource cannot be secured is requested. Further, the “some-flow switching flag” indicates that the UE 10 has a function of being capable of performing such a handover.

The MME 40 identifies the SGSN 50 that receives the relocation request, from the identification information of the NB 70 included in the received handover request by managing the base station located in the access network B and the SGSN connected to the access network B in advance.

(4) The SGSN 50 receives the relocation request that the MME 10 transmits, and transmits the resource allocation request to the NB 70 (S106). The SGSN 50 identifies the NB 70 of the transmission destination, from the identification information of the NB 70 included in the received relocation request.

The SGSN 50 makes a request for allocation of a resource for the communication flow of the UE 10 to the NB 70, by transmitting a resource allocation request. Therefore, the SGSN 50 transmits the relocation request message by including information for calculating a resource which is required for the UE 10 to continue communication such as the identification information regarding a flow being communicated by the UE 10 and QoS information regarding the flow.

Further, when the “some-flow switching flag” is included in the received relocation request message, the SGSN 50 transmits the resource allocation request message while attaching the “some-flow switching flag”.

(5) The NB 70 receives the resource allocation request, calculates a required resource based on the identification information regarding a flow being communicated by the UE 10 and QoS information regarding the flow, and checks whether the resource can be secured for the UE 10.

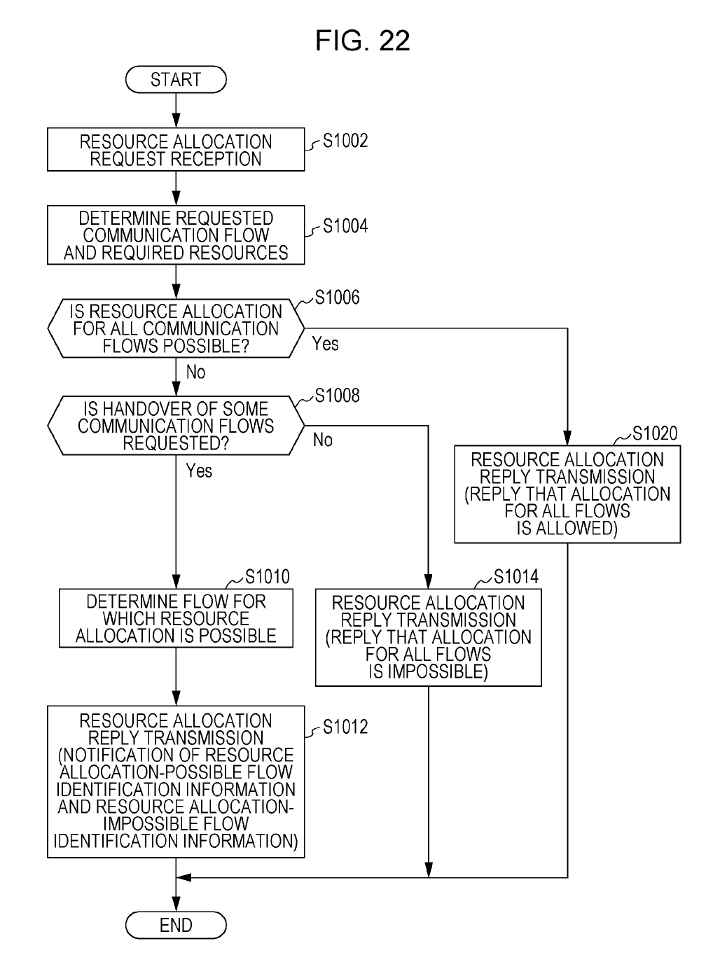

The NB 70 transmits a resource allocation reply to the SGSN 50 (S108). With reference to FIG. 22, a processing flow for the resource allocation reply transmission by the NB 70 will be described.

First, the NB 70 receives the resource allocation request (step S1002). The NB 70 determines whether or not to be able to secure all of the requested resource (step S1004).

When it is possible to secure all of the requested resources (step S1006; Yes), the NB 70 notifies the SGSN 50 that all resources can be secured (step S1020). The notification means may transmit a resource allocation reply by including flow identification information for allowing handover, or may provide a new flag indicating that all of the resources of the requested communication flows can be secured and transmit a resource allocation reply by assigning the new flag.

When the resources of some communication flows among a plurality of communication flows cannot be secured (step S1006; No), the NB 70 determines whether or not “the some-flow switching flag” is assigned in the received resource allocation request (step S1008).

When there is the “some-flow switching flag” (step S1008; Yes), the NB 70 determines whether the communication flow is the communication flow for which the resource can be secured or the communication flow for which the resource cannot be secured (step S1010). In the present embodiment, it is detected that the resource of the “flow 1” can be secured and the resource of the “flow 2” cannot be secured.

Further, the NB 70 transmits the resource allocation reply to the SGSN 50 (step S1012). Through the resource allocation reply, it is notified that it is possible to secure the resources of some communication flows out of the communication flows for which a handover is requested, and perform the handover of the communication flows, and it is not possible to secure the resources of the other communication flows and perform the handover of the communication flows.

For example, as the specific notification means, a new flag indicating that some communication flows cannot be handed over may be provided and a resource allocation reply may be transmitted by assigning the flag and flow identification information; or a new flag indicating that some communication flows can be handed over may be provided and a resource allocation reply may be transmitted by assigning the flag and flow identification information.

Further, when “the some-flow switching flag” is not assigned in the received resource allocation request (step S1008; No), as in the related art, the NB 70 transmits a resource allocation reply to the SGSN 50 by assigning information for notifying that a handover is impossible (step S1014).

Through the above processing flow of FIG. 22, the NB 70 determines whether the resource can be secured for all communication flows, the resource can be secured only for some communication flows, or the resource cannot be secured for all communication flows, with respect to the received resource allocation request, and can transmit the resource allocation reply to the SGSN 50.

(6) The SGSN 50 receives the resource allocation reply. It is possible to determine whether all requested resources can be secured, the resource can be secured only for some communication flows or the resource cannot be secured for all communication flows, in response to the resource request, from the resource allocation reply.

The SGSN 50 transmits the relocation reply to the MME 40 (S110). The relocation reply is transmitted by including the flow identification information.

When the resource can be secured for some of the flows, the identification information regarding the flow for which the resource can be secured and the identification information regarding the flow for which the resource cannot be secured are included in the relocation reply and the relocation reply is transmitted to the MME 40. For example, it is notified that it is possible to perform the handover of the “flow 1” but it is not possible to perform the handover of the “flow 2”.

When the resource can be secured for all of the flows, the identification information regarding all of the flows that can be handed over may be included, or as in the related art, it may be notified that a handover is allowed.

When the resource cannot be secured for all of the flows, the identification information regarding all of the flows that cannot be handed over may be included, or as in the related art, it may be notified that a handover is disabled.

(7) The MME 40 receives the relocation reply, and transmits the handover instruction to the eNB (S112). The MME 40 instructs the handover to the UE 10, by transmitting the handover instruction. The handover instruction is transmitted by including the flow identification information and the identification information of the switching target NB 70.

Through the handover instruction, notification of whether to perform the handover of all communication flows or to perform the handover of some communication flows is performed, in response to the received relocation reply. When all of the flows cannot be handed over, without performing the instruction of the handover, communication continues through the transfer path over the access network A.

When all communication flows can be handed over, the notification of the communication flow to be handed over may be performed by transmitting the handover instruction by including the flow identification information of all communication flows that the UE 10 performs, or as in the related art, the handover instruction for instructing the switching of all communications may be transmitted.

When only some communication flows can be handed over, the handover instruction is transmitted by including the flow identifier of the communication flow that can be handed over and the flow identifier of the communication flow that cannot be handed over.

Specifically, it is notified that the “flow 1” can be handed over to the NB 70 and the “flow 2” cannot be handed over to the NB 70.

(8) The eNB 60 receives the handover instruction, and transmits the handover instruction to the UE 10 (S114). The eNB 60 instructs the handover to the UE 10, by transmitting the handover instruction. The handover instruction is transmitted by including the flow identification information and the identification information of the switching target NB 70.

Through the handover instruction, notification of whether to perform the handover of the all communication flows or some communication flows is performed, in response to the handover instruction received from the MME 40.

When all of the communication flows can be handed over, the notification of the communication flow to be handed over may be performed by transmitting the handover instruction by including the flow identification information of all communication flows that the UE 10 performs, or as in the related art, the handover instruction for instructing the switching of all communications may be transmitted.

When only some communication flows can be handed over, the handover instruction is transmitted by including the flow identifier of the communication flow that can be handed over and the flow identifier of the communication flow that cannot be handed over.

Specifically, it is notified that the “flow 1” can be handed over to the NB 70 and the “flow 2” cannot be handed over to the NB 70.

(9) Further, when the eNB 60 receives the handover instruction (S112) and instructs the handover by transmitting the handover instruction to the UE 10 (S114), the eNB 60 establishes a data transfer path with the NB 70, and starts data transmission (S115).

The eNB 60 determines whether it is possible to perform the handover of all communication flows or to perform the handover of some communication flows, or establishes the data transfer path and starts data transmission.

When only some communication flows can be handed over, data transmission is performed of only the communication flow identified by the flow identifier of the communication flow that can be handed over. Data transmission is not performed of the communication flow identified by the flow identifier of the communication flow that cannot be handed over.

Specifically, data transmission is performed of the “flow 1” that can be handed over to the NB 70, and data transmission is not performed of the “flow 2” that cannot be handed over to the NB 70.

The NB 70 receives the transmitted data, and buffers the transmitted data until the UE 10 is ready to receive the data transmitted by the NB 70.

(10) The UE 10 receives the handover instruction. It is possible to determine whether to hand over all of the communication flows as in the related art, or to hand over only some communication flows to the NB 70, based on the identifier of the NB 70 and the flow identification information included in the handover instruction.

When it is determined that all communication flows can be handed over, the handover procedure of the related art continues. Since the continued handover procedure is the same as the procedure of the communication system of the related art, the detailed description will be omitted.

When it is determined that only some communication flows can be handed over, the communication flows to be handed over and the communication flows not to be handed over are determined from the received handover instruction.

Specifically, it is determined that the “flow 1” can be handed over and the “flow 2” cannot be handed over, among the communication flows that the UE 10 communicates.

Thus, although the UE 10 of the communication system in the related art can receive only the handover instruction for performing hand over all of a plurality of communication flows that the UE 10 communicates, it is possible to determine the communication flows that can be handed over and the communication flows that cannot be handed over, depending on whether or not the resources of the NB 70 located in the access network of a handover destination can be secured by the handover method of the present embodiment.

(Modification)

Here, in the embodiment described above, the example has been described in which the NB 70 determines whether or not the resource of the NB 70 can be secured, but the SGSN 50 may manage the resource consumption situation of the NB 70 in real time, and the SGSN 50 may determine whether or not the resource of the NB 70 can be secured.

In this case, the SGSN 50 transmits the resource allocation request to the NB 70 by assigning only the flow identification information of the communication flows that the NB 70 can secure the resource.

For example, the SGSN 50 determines that the resource allocation of the “flow 1” can be secured in the NB 70 and the resource allocation of the “flow 2” cannot be secured in the NB 70, among the “flow 1” and the “flow 2” that the UE 10 communicates.

The SGSN 50 transmits the resource allocation request to the NB 70 by assigning the flow identification information of the “flow 1”, and performs resource allocation in the NB 70.

Further, if the SGSN 50 receives the resource allocation reply from the NB 70, it transmits the relocation reply to the MME 40. The relocation reply can be transmitted by including the flow identification information that can be switched to the NB 70 and the flow identification information that cannot be switched to the NB 70, similar to the already described procedure.

Accordingly, the procedure subsequent to the SGSN 50 transmitting the relocation reply to the MME 40 can be performed as the same procedure even in the present modification.

In this manner, in the modification, it is not necessary for the NB 70 to have a function of determining the availability of a new resource allocation, and it is possible to instruct a handover of some communication flows to the UE 10.

Subsequently, the UE 10 performs an execution process of switching to the transfer path over the access network B. In the execution process of switching, the UE 10 switches only the communication flow that can be handed over to the transfer path over the access network, to the transfer path to the PGW 20 through the NB 70, the SGSN 50, and the SGW 50.

(11) The UE 10 transmits a handover completion notification to the NB 70 from the second transceiver unit 120 such that the UE 10 notifies that the handover process of the communication flow of the UE 10 of which the resource can be secured is completed through the transfer path of the access network B (S116).

The handover completion notification is transmitted by including the flow identification information of the communication flow to be switched.

At the time of transmission of the handover completion notification, the UE 10 updates the UE flow management table 132 and switches the transfer path of the communication flow to be handed over from the transfer path A over the access network A to the transfer path B over the access network B.

Specifically, the transfer path for the “flow 1” is updated from the transfer path A over the access network A illustrated in FIG. 12(b) to the transfer path B over the access network B illustrated in FIG. 12(c), and the transmission and reception of the “flow 1” is switched to the transfer path through the NB 70.

(12) The NB 70 receives the handover completion notification and starts the transmission and reception of the flow of the UE 10 that is identified with the flow identification information.

At the time of starting the transmission and reception of the flow, the NB flow management table 722 is updated, and as illustrated in FIG. 18(b), the “flow 1” of the UE 10 is managed as the object to be transmitted and received.

The NB 70 transmits the relocation completion notification to the SGSN 50, and notifies that the UE 10 and the NB 70 has completed the handover process of the communication flow of the UE 10 of which the resource can be secured in the transfer path B over the access network B (S118). The relocation completion notification is transmitted by including the flow identification information of the communication flow to be switched.

(13) Further, the NB 70 that receives the handover instruction from the UE 10 (S114) transmits the communication data that has been transmitted from the eNB 60 to the UE 10 (S119). When the data transmitted from the eNB 60 is buffered in the buffer, the buffered data is started to be transmitted to the UE 10.

Thus, when only some communication flows can be handed over, it is possible to transmit only the communication flows that are identified with the flow identifier of the communication flows that can be handed over to the UE 10. The communication flows that are identified with the flow identifier of the communication flows that cannot be handed over are not transmitted from the NB 70 to the UE 10.

In this manner, prior to starting the handover procedure, the data destined for the UE 10 from the PGW 20 is transmitted to the UE 10 through the SGW 30 and the eNB 60, but for the time being until the handover procedure is completed after being started, the data transmitted from the PGW 20 is transmitted to the UE 10 through the SGW 30, the eNB 60, and the NB 70.

(14) The SGSN 50 starts the relocation completion notification and starts the transmission and reception of the flow of the UE 10 that is identified with the flow identification information.

At the time of starting the transmission and reception of the flow, the SGSN flow management table 522 is updated, and as illustrated in FIG. 16(b), the “flow 1” of the UE 10 is managed as the object to be transmitted and received.

The SGSN 50 transmits the relocation completion notification to the MME 40 and notifies that the UE 10, the NB 70, and the SGSN 50 have completed the handover process of the communication flow of the UE 10 of which the resource can be secured in the transfer path B over the access network B (S120). The relocation completion notification is transmitted by including the flow identification information of the communication flow to be switched.

(15) The MME 40 receives the relocation completion notification, and determines that the UE 10, the NB 70, and the SGSN 50 have completed the handover process of the communication flow of the UE 10 of which the resource can be secured in the transfer path over the access network B.

The MME 40 updates the MME flow management table 422, and switches the transfer path of the communication flow for the handover of the UE 10 from the transfer path over the access network A to the transfer path over the access network B.

Specifically, as illustrated in FIG. 15(b), the transfer path for the “flow 1” is updated from the transfer path A over the access network A to the transfer path B over the access network B, and the transfer path information regarding the “flow 2” is deleted (FIG. 15(c)).

Further, the MME 40 determines that there are communication flows that cannot be handed over to the transfer path B over the access network B, from the MME flow management table 422.

Specifically, it is determined that the “flow 2” is in a state of the resource of the access network B and the transfer path over the access network B cannot be handed over.

When it is determined that there are communication flows that cannot be handed over to the transfer path B over the access network B, or when it is checked that the UE 10 has the capability based on the UE capability information management table 424, differently from the related art, the relocation completion notification reply is transmitted by assigning a flag (hereinafter, referred to as a “some-flow switching flag”) indicating the handover for allowing some-flow switching depending on the switching target resource, which is described in the present embodiment and different from the related art (S122).

Further, the flow identification information regarding the communication flow that cannot be handed over to the transfer path B over the access network B may be assigned in the relocation completion notification reply. Specifically, flow identification information for identifying the “flow 2” may be assigned.

Regardless of the relocation request message, the “some-flow switching flag” is assigned in the control message, because when sufficient resources of a handover destination access network are not secured and only some of the flows are not switched, the handover of all of the flows is not rejected as in the related handover, the flow for which the resource can be secured is handed over, and after determination, the notification of the flow for which the resource cannot be secured is requested. Further, the “some-flow switching flag” indicates that the UE 10 has a function of being capable of performing such a handover.

(16) The SGSN 50 receives the relocation completion notification reply, and transmits bearer update request to the SGW 30 so as to notify that the UE 10, the NB 70, the SGSN 50, and the MME 40 have completed the handover process of the communication flow of the UE 10 of which the resource can be secured in the transfer path over the access network B and there are communication flows of which the resource cannot be secured in the transfer path B over the access network B (S124).

Through the bearer update request, the SGSN 50 makes a request for a change in the transfer path of the communication flow to be switched, to the SGW 30 and the PGW 20.

The bearer update request is transmitted by including the flow identification information of the communication flows to be switched and the flow identification information of the communication flows that cannot be switched. Further, the bearer update request is transmitted by assigning the “some-flow switching flag” indicating the handover for allowing some-flow switching depending on the switching target resource, which is different from the related art.

Specifically, it is notified that the “flow 1” can be switched to the transfer path B over the access network B and the “flow 2” cannot be switched to the transfer path B over the access network B, among the communication flows that the UE 10 communicates.

At the time of the transmission of the bearer update request, the SGSN 50 updates the SGSN flow management table 522, and as illustrated in FIG. 16(b), manages the “flow 1” of the UE 10 as the object to be transmitted and received.

Further, the SGW 30 performs the transmission and reception of the “flow 1” by using the transfer path over the access network B, based on the SGW flow management table 322.

(17) The SGW 30 receives the bearer update request and transmits the bearer update request to the PGW 20 so as to notify that the UE 10, the NB 70, the SGSN 50, the MME 40, and the SGW 30 have completed the handover process of the communication flow of the UE 10 of which the resource can be secured in the transfer path over the access network B and there are communication flows of which the resource cannot be secured in the transfer path B over the access network B (S126).

Through the bearer update request, the SGW 30 makes a request for a change in the transfer path of the communication flow to be switched, to the PGW 20, based on the request of the SGSN 30.

The bearer update request is transmitted by including the flow identification information of the communication flows to be switched and the flow identification information of the communication flows that cannot be switched. Further, the bearer update request is transmitted by assigning the “some-flow switching flag” indicating the handover allowing for some-flow switching depending on the switching target resource, which is different from the related art.

Specifically, it is notified that the “flow 1” can be switched to the transfer path B over the access network B and the “flow 2” cannot be switched to the transfer path B over the access network B, among the communication flows that the UE 10 communicates.

At the time of the transmission of the bearer update request, the SGW 30 updates the SGW flow management table 322, and manages the flows to be communicated through the access network B. Specifically, as illustrated in FIG. 14(b), whereas the transfer path A over the access network A has been managed for the “flow 1” and the transfer path A over the access network A has been managed for the “flow 2”, the SGW flow management table 322 is updated such that the transfer path B over the access network B is managed for the “flow 1” and the transfer path information regarding the “flow 2” is deleted (FIG. 14(c)).

Further, the SGW 30 performs the transmission and reception of the “flow 1” by using the transfer path B over the access network B, based on the SGW flow management table 322.

(18) The PGW 20 receives the bearer update request, and determines that the UE 10, the NB 70, the SGSN 50, the MME 40, and the SGW 30 have completed the handover process of the communication flow of the UE 10 of which the resource can be secured in the transfer path over the access network B and there are communication flows of which the resource cannot be secured in the transfer path over the access network B.

Specifically, it is determined that the “flow 1” can be switched to the transfer path over the access network B and the “flow 2” cannot be switched to the transfer path over the access network B, among the communication flows that the UE 10 communicates.

Through the reception of the bearer update request, the PGW 20 updates the PGW flow management table 222, and manages the flows to be communicated through the access network B. Specifically, as illustrated in FIG. 13(b), whereas the transfer path A over the access network A has been managed for the “flow 1”, the PGW flow management table 222 is updated such that the transfer path B over the access network B has been managed for the “flow 1” (FIG. 13(c)).

Further, the PGW 20 performs the transmission and reception of the “flow 1” by using the transfer path over the access network B, based on the PGW flow management table 222.

Since the “some-flow switching flag” is assigned which indicates the handover for allowing some-flow switching depending on the switching target resource, different from the related art, it is determined that the UE 10 continues communication by using a transfer path over the access network C, with respect to the communication flow for which switching to the transfer path over the access network B is impossible.

Specifically, the PGW 20 determines that the “flow 2” of the UE 10 cannot be switched to the transfer path B over the access network B, and determines that a request for the switching to the transfer path C over the access network C is made by the UE 10.

Thus, the PGW 20 has the information regarding the “flow 2” until the request for the switching to the transfer path C over the access network C arrives. Further, the PGW 20 may be equipped with a buffer, and temporarily buffers the data of the “flow 2” transmitted to the PGW 20.

Further, when the “some-flow switching flag” is not assigned in the bearer update request, information regarding the transfer path for the “flow 2” may be deleted.

Thereafter, the PGW 20 transmits a bearer update reply to the SGW 30, and notifies that the switching of the transfer path has been completed (S128).

(19) The SGW 30 receives the bearer update reply, transmits the bearer update reply to the SGSN 50, and notifies that the switching of the transfer path has been completed (S130).

Through the above procedure, the eNB 70 located in the access network A initiatively starts the switching to the transfer path over the access network B, with respect to the communication flows that are transmitted through the transfer path over the access network A, and the UE 10 is able to determine the communication flow that can be handed over and the communication flow that cannot be handed over, depending on the resource state of the access network B.

Further, the PGW 20 also can determine the communication flow that can be handed over and the communication flow that cannot be handed over, depending on the resource state of the access network B, and detect that the switching to the transfer path over the access network C is requested for such a communication flow.

Further, the eNB 60 also can determine whether all of the communication flows can be handed over or some of the communication flows can be handed over, and establish a data transfer path to the NB 70 only with respect to the communication flows that can be handed over so as to start the data transmission.

The NB 70 also can receive data transmitted from the eNB 60 only with respect to the communication flow that can be handed over, and transmit the data to the UE 10.

Specifically, with respect to the “flow 1” of which the resource can be secured in the access network B, out of the “flow 1” and the “flow 2” that have been communicated through the transfer path established with the PGW 20, through the eNB 60 and the SGW 30 from the first transceiver unit 110 of the UE 10, a transfer path with the PGW 20 is established from the second transceiver unit 120 of the UE 10 through the NB 70, the SGSN 50, and the SGW 30, and switching is performed, such that communication can be continued.

Further, during the handover procedure, it is possible to temporarily perform data transmission of the communication data of the “flow 1” from the eNB 60 to the NB 70, and transmit the data that has been transmitted from the PGW 20, to the UE 10 through the SGW 30, the eNB 60, and the NB 70.

The UE 10 can receive communication data transmitted between the base stations even during the handover procedure.

Further, each device can detect that the resource for the “flow 2” cannot be secured in the access network B.

Further, it is possible to determine whether or not to perform the handover procedure which is different from the related art depending on the presence or absence of the capability information of the UE 10.

The flow identification information is information enabling the identification of a plurality of communication flows that the UE 10 communicates, and performs the identification by using, for example, a traffic flow template (TFT) as described already. The TFT is an identification information group including an IP address, a port number, a protocol number, a domain name of a connection destination, application identification information, and the like, and for example, the “flow 1” can be identified by the TFT among a plurality of communication flows that the UE 10 communicates.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

In this manner, the UE 10 can perform the transfer path switching per a communication flow identified with the TFT, perform the transfer path switching per a PDN connection, and perform the transfer path switching per a bearer ID.

(Modification)

Here, the respective devices located in the core network which have been described hereto may be implemented as one device. For example, the SGSN 50 and the SGW 30 may be physically made as two devices, or may be made as one device.

When the SGSN 50 and the SGW 30 are made as one device, the transmission and reception of a control message between the SGSN 50 and the SGW 30 which has been described hereto is an internal process within the device.

The same is applied to other devices such as the SGW 30 and the PGW 20. Further, three devices may be made as one device.

[1.5 Switching Procedure to WLAN]

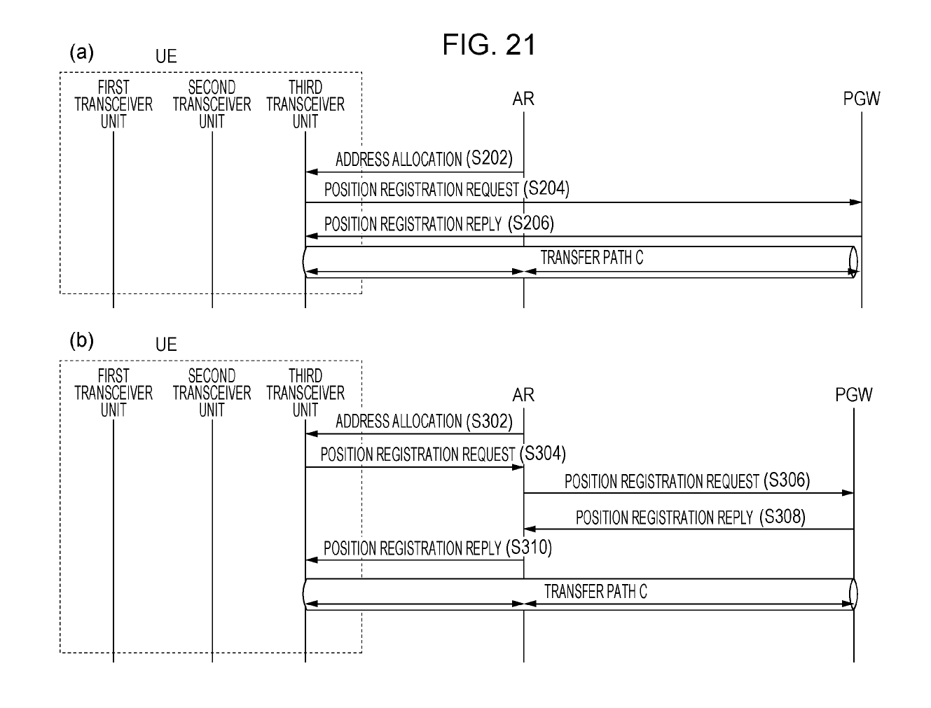

Next, a description will be made regarding a procedure for continuing communication by switching the communication flow that cannot be switched to the transfer path over the access network B among the communication flows of the UE 10, to the transfer path over the access network C, with reference to FIG. 21(a).

Through the procedure hereto, the UE 10 determines to continue the communication of the “flow 2” through the transfer path C over the access network C.

(1) The UE 10 acquires the IP address from the AR 80 by the third transceiver unit 140 (S202). The acquisition means of the IP address may acquire the IP address by using the control message such as the DHCP and the RA that are well known.

(2) A position registration request is transmitted to the PGW 20 by using the acquired IP address (S204). The position registration is transmitted by assigning the flow identification information of the “flow 2” requesting the switching. The UE 10 holds the identification information such as the IP address of the PGW 20 for the transmission of the position registration request, or includes determination means of the PGW 20.

The PGW 20 receives the position registration request, and updates the PGW flow management table 222. Specifically, as illustrated in FIG. 13(c), the transfer path for the “flow 2” is updated to the transfer path C over the access network C.

Thus, the PGW 20 establishes the transfer path C over the access network C for the UE 10, and switches the transfer path through which the data transmission and reception of the “flow 2” is performed.

When the PGW 20 has buffered the transmission and reception data of the “flow 2”, the transfer path is established and the transmission to the UE 10 is started.

The PGW 20 transmits the position registration reply to the UE 10 in order to notify the transfer path establishment (S206). The position registration reply may be transmitted by including the IP address that the UE 10 has used when the communication of the “flow 2” has been performed through the transfer path over the access network A.

(3) The UE 10 receives the position registration reply, checks that the transfer path through the access network C can be established, and continues the communication of the “flow 2” by switching to the transfer path C through the access network C.

The UE 10 updates the UE flow management table 132 for the transfer path switching. Specifically, as illustrated in FIG. 12(c), the transfer path for the “flow 2” is updated to the transfer path C over the access network C.

The UE 10 may perform a communication of the “flow 2”, by using the IP address included in the position registration reply. In this case, the communication can be continued by using the same IP address before and after the switching of the transfer path.

Through the above procedure, the UE 10 can continue the communication by switching the communication flow that could not be switched to the transfer path B over the access network B due to the situation of the resource of the access network B, to the transfer path C over the access network C.

Specifically, the UE 10 establishes the transfer path C over the access network C with the PGW 20, and continues the communication of the “flow 2”.

Further, the position registration request that UE 10 transmits to the PGW 20 may be transmitted by using the message defined in protocols such as DSMIP.

Through the above procedure, the eNB 70 located in the access network A initiatively starts the switching to the transfer path B over the access network B, with respect to the communication flows that are transmitted through the transfer path over the access network A, and the UE 10 is able to determine the communication flow that can be handed over and the communication flow that cannot be handed over, depending on the resource state of the access network B.

Further, the PGW 20 also can determine the communication flow that can be handed over and the communication flow that cannot be handed over, depending on the resource state of the access network B, and detect that the switching to the transfer path C over the access network C is requested for such a communication flow.

Further, the eNB 60 also can determine whether all of the communication flows can be handed over or some of the communication flows can be handed over, and establish a data transfer path to the NB 70 only with respect to the communication flows that can be handed over so as to start the data transmission.

The NB 70 also can receive data transmitted from the eNB 60 only with respect to the communication flow that can be handed over, and transmit the data to the UE 10.

The UE 10 can receive communication data transmitted between the base stations even during the handover procedure.

Specifically, with respect to the “flow 1” of which the resource can be secured in the access network B out of the “flow 1” and the “flow 2” that have been communicated through the transfer path to the PGW 20 which is established through the eNB 60 and the SGW 30 from the first transceiver unit of the UE 10, a transfer path to the PGW 20 is established through the NB 70, the SGSN 50, and the SGW 30 from the second transceiver unit 120 of the UE 10 and switching is performed, such that communication can be continued.

Further, during the handover procedure, it is possible to temporarily perform data transmission of the communication data of the “flow 1” from the eNB 60 to the NB 70, and transmit the data that has been transmitted from the PGW 20, to the UE 10 through the SGW 30, the eNB 60, and the NB 70.

Further, each device detects that the resource of the “flow 2” cannot be secured in the access network B, the transfer path C over the access network C is established with the PGW 20, and the transfer path is switched, such that it is possible to continue the communication of the “flow 2”.

Further, it is possible to determine whether or not to perform the handover procedure which is different from the related art depending on the presence or absence of the capability information of the UE 10.

The flow identification information is information enabling the identification of a plurality of communication flows that the UE 10 communicates, as already described, and performs the identification by using, for example, a traffic flow template (TFT). The TFT is an identification information group including an IP address, a port number, a protocol number, a domain name of a connection destination, application identification information, and the like, and for example, the “flow 1” can be identified by the TFT among a plurality of communication flows that the UE 10 communicates.

A PDN connection identifier other than the TFT may be used for the flow identification information. In this case, the UE 10 can establish a different PDN connection for each communication flow, and identify the “flow 1” by using the PDN connection identifier. Here, the PDN connection indicates a communication connection between the UE 10 and the PGW 20 used in the communication system of an SAE specification.

Further, a bearer ID may be used for the flow identification information. In this case, the UE 10 can establish a different bearer for each communication flow, and identify the “flow 1” by using the bearer ID. Here, the bearer ID is identification information for identifying the bearer that is established as the transfer path when the UE 10 is connected to a LTE access network or a 3G or 2G access network.

In this manner, the UE 10 can perform the transfer path switching per a communication flow identified with the TFT, perform the transfer path switching per a PDN connection, and perform the transfer path switching per a bearer ID.

Further, in the present embodiment, the description has been made in which the access network B is a 3G access network, but it is possible to perform the switching of the transfer path by the same procedure even in the case where the access network B is a 2G access network.

### 2. Second Embodiment

Next, a second embodiment will be described.

Since the network configuration and the configuration of each device are the same as the configurations described in the first embodiment, a description thereof will be omitted.

The second embodiment has a procedure different from the first embodiment in that communication is continued by switching the communication flows that could not be switched to the transfer path B over the access network B among the communication flows of the UE 10, to the transfer path C over the access network C.

The procedure of the present embodiment will be described with reference to FIG. 21(b). The UE 10 determines to continue the communication of the “flow 2” through the transfer path over the access network C.

(1) The UE 10 acquires the IP address from the AR 80 by the third transceiver unit 140 (S302). The acquisition means of the IP address may acquire the IP address by using the control message such as the DHCP and the RA that are well known.

(2) A position registration request is transmitted to the AR 80 by using the acquired IP address (S304). The position registration is transmitted by assigning the flow identification information of the “flow 2” requesting the switching.

(3) The AR 80 receives the position registration request, and transmits the position registration request to the PGW 20 (S306). The position registration is transmitted by assigning the flow identification information of the “flow 2” requesting the switching.

The AR 80 holds the identification information such as the IP address of the PGW 20 for the transmission of the position registration request, or includes determination means of the PGW 20.

(4) The PGW 20 receives the position registration request, and updates the PGW flow management table 222. Specifically, as illustrated in FIG. 13(c), the transfer path for the “flow 2” is updated to the transfer path C over the access network C.

Thus, the PGW 20 establishes the transfer path over the access network C for the UE 10, and switches the transfer path through which the data transmission and reception of the “flow 2” is performed.

When the PGW 20 has buffered the transmission and reception data of the “flow 2”, the transfer path is established and the transmission to the UE 10 is started.

The PGW 20 transmits the position registration reply to the AR 80 in order to notify the transfer path establishment (S308). The position registration reply may be transmitted by including the IP address that the UE 10 has used when the communication of the “flow 2” has been performed through the transfer path over the access network A.

(5) The AR 80 receives the position registration reply, checks that the transfer path through the access network C can be established, and transmits the position registration reply to the UE 10 (S310). Thus, the communication of the “flow 2” is started through the transfer path over the access network C.

The position registration reply may be transmitted by including the IP address that the UE 10 has used when the communication of the “flow 2” has been performed through the transfer path over the access network A.

The AR 80 updates the AR flow management table 832 for the transfer path switching. Specifically, as illustrated in FIG. 19(c), the “flow 2” is managed as the flow that is communicated through the transfer path over the access network C.

(6) The UE 10 receives the position registration reply, checks that the transfer path through the access network C can be established, and continues the communication of the “flow 2” by switching to the transfer path through the access network C.

The UE 10 updates the UE flow management table 132 for the transfer path switching. Specifically, as illustrated in FIG. 12(c), the transfer path for the “flow 2” is updated to the transfer path C over the access network C.

The UE 10 may perform a communication of the “flow 2”, by using the IP address included in the position registration reply. In this case, the communication can be continued by using the same IP address before and after the switching of the transfer path.

Through the above procedure, the UE 10 can continue the communication by switching the communication flow that could not be switched to the transfer path B over the access network B due to the situation of the resource of the access network B, to the transfer path C over the access network C.

Specifically, the UE 10 establishes the transfer path over the access network C with the PGW 20, and continues the communication of the “flow 2”.

Further, the position registration request and the position registration reply which have been transmitted and received by the UE 10, the AR 70, and the PGW 20 may be transmitted by using the message defined in protocols such as PMIP or GTP.

Thus, in the present embodiment, unlike the first embodiment, it is not necessary for the UE 10 to hold the identification information such as the address of the PGW 20, and it is possible to establish a transfer path only by transmission and reception of the control messages with the AR.

### 3. Third Embodiment

Next, a third embodiment will be described.

Since the network configuration and the configuration of each device are the same as the configurations described in the first embodiment, a description thereof will be omitted.

A procedure is different from the first embodiment in that communication is continued by switching the communication flow that cannot be switched to the transfer path over the access network B, among the communication flows of the UE 10, to the transfer path C over the access network C.

The UE 10 determines to continue the communication of the “flow 2” through the transfer path over the access network C.

The UE 10 acquires the IP address from the AR 80 through the third transmission and reception. The acquisition means of the IP address may acquire the IP address by using the control message such as the DHCP and the RA that are well known.

The UE 10 starts the communication of the “flow 2”, with the IP address acquired from the AR 80 as a transmission and reception source address.

In this manner, the UE 10 continues the communication by changing the IP address. Specifically, the communication is continued by changing the IP address used for the communication of the “flow 2” from the IP address used when performing the communication through the transfer path A over the access network A to the IP address acquired from the AR 80.

Thus, the UE 10 performs the communication by using the IP address that is obtained from the AR 80, rather than the communication with the PGW 20 as an anchor.

Through the above procedure, unlike the first embodiment and second embodiment, it is possible to reduce the amount of transmission and reception, and process of the control information associated with the position registration in the UE 10, the AR 80, and the PGW 20.

### 4. Fourth Embodiment

Next, a fourth embodiment will be described.

Since the network configuration and the configuration of each device are the same as the configurations described in the first embodiment, a description thereof will be omitted.

In the present embodiment, a data transmission method performed in the eNB 60 and the NB 70 for the time being while the handover procedure is performed is different from that in the first embodiment.

Whereas the data transfer path is established through which direct transmission and reception is possible between the eNB 60 and the NB 70 as illustrated in the data transmission (S115) of FIG. 20 for the data transmission in the first embodiment, the data transmission between the eNB 60 and the NB 70 is performed through the SGW 30 in the present embodiment.

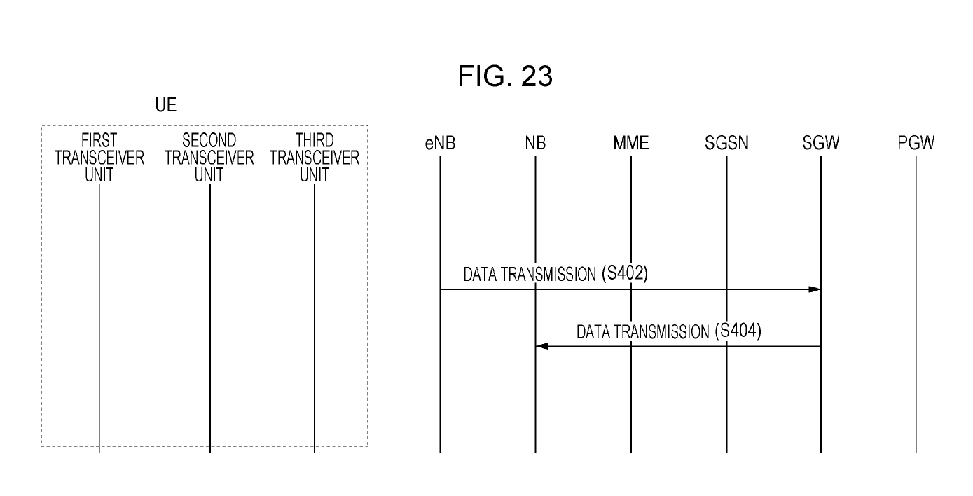

Instead of the data transmission (S115) in the first embodiment illustrated in FIG. 20, in the present embodiment, as illustrated in FIG. 23, the eNB 60 transmits the transmission data to the SGW 30.

Further, the SGW 30 transmits the received data to the NB 70. This enables the data transmission between the eNB 60 and the NB 70.

In the data transmission of the present embodiment, since it is not necessary to establish the direct data transfer path between the eNB 60 and the NB 70, the process is simplified.

Since the selection of the communication flow for performing data transmission performed by the eNB 60 is the same as in the first embodiment, a description thereof will be omitted.

Further, since the procedure before and after the data transmission is the same as in the first embodiment, a detailed description thereof will be omitted.

Further, with respect to a method for switching the communication flow that could not be switched to the transfer path B over the access network B to transfer path C over the access network C, of course, it is possible to apply not only the method described in the first embodiment but also the method described in the second embodiment and third embodiment to the present embodiment.

In this manner, according to the present embodiment, in a control station performing communication of a plurality of communication flows through the transfer path over the first access network with a mobile station connectable to a first access network such as an LTE access network in which a base station initiatively performs a handover procedure by switching access networks, to a second access network such as a 3G access network which is different from the first access network in a transmission capability and usage situation of the communication resource, and to a third access network such as a WLAN access network in which the mobile station initiatively performs a handover by switching access networks, the base station located in the first access network initiatively starts a handover procedure to the second access network, performs handover by selecting a communication flow that can be accommodated in the second access network, and notifies the mobile station of a communication flow that cannot be accommodated in the second access network, and the mobile station starts and executes the handover procedure to switch these communication flows to the third access network, to thereby continue the communication.

Further, the base station of the LTE access network that starts the handover procedure determines the communication flow that can be switched to the switching target 3G access network, performs data transmission of the communication flow that can be switched, to the base station of the 3G access network.

Accordingly, while the mobile station located away from the LTE access network area continues the communication by effectively utilizing the communication resource of the 3G access network as much as possible, the communication flow that cannot be continuously communicated in the 3G access network can be continuously communicated by utilizing the WLAN access network, it is possible to effectively utilize a plurality of access network resources, and it is possible to avoid the disconnection of communication.

### 5. Modification

Hitherto, the embodiments of the present invention have been described with reference to the drawings, but the specific configuration is not intended to be limited to the embodiments, and a design change is included in the claims without departing from the spirit of the invention.

Further, a program operating in each device in each embodiment is a program for controlling the CPU and the like (a program for causing a computer to function) so as to realize the functions of the embodiment described above. Then, information handled by these devices is temporarily stored in a temporary storage device (for example, RAM) during the process, thereafter, stored in storage devices of the various types of ROMs and HDD, is read by the CPU as necessary, and modified and written.

Here, examples of a recording medium for storing a program include a semiconductor medium (for example, a ROM, a nonvolatile memory card, and the like), an optical recording medium, a magneto-optical recording medium (for example, a digital versatile disc (DVD), a magneto optical disc (MO), a mini disc (MD), a compact disc (CD), a BD, and the like), a magnetic recording medium (for example, a magnetic tape, a flexible disk, and the like), and the like. Further, the functions of the embodiment described above may be implemented by executing the loaded program, and the functions of the present invention may be implemented in conjunction with an operating system or other application programs, based on instructions of the program.

Further, when the program is distributed on the market, it can be distributed by the program being stored in a portable recording medium, or can be transmitted to a server computer connected through a network such as the Internet. In this case, of course, a storage device of a server computer is included in the present invention.

Further, some or all of the respective devices in the above-described embodiments may be typically implemented as large scale integration (LSI) which is an integrated circuit. Respective functional blocks of each device may individually made into chips, or some or all may be integrated and made into chips. Further, a circuit integration method is not limited to the LSI, but may be implemented by a dedicated circuit or a general-purpose processor. Further, when an alternative circuit integration technology of the LSI has emerged due to the advancement of semiconductor technology, of course, it is also possible to use an integrated circuit according to the technology.

### REFERENCE SIGNS LIST

1 MOBILE COMMUNICATION SYSTEM
10 UE
100 CONTROL UNIT
110 FIRST TRANSCEIVER UNIT
120 SECOND TRANSCEIVER UNIT
130 STORAGE UNIT
132 UE FLOW MANAGEMENT TABLE
140 THIRD TRANSCEIVER UNIT
150 TRANSFER PATH ESTABLISHMENT PROCESSING UNIT
160 PACKET TRANSCEIVER UNIT
20 PGW
200 CONTROL UNIT
210 TRANSCEIVER UNIT
220 STORAGE UNIT
222 PGW FLOW MANAGEMENT TABLE
230 TRANSFER PATH ESTABLISHMENT PROCESSING UNIT
240 PACKET TRANSCEIVER UNIT
30 SGW
300 CONTROL UNIT
310 TRANSCEIVER UNIT
320 STORAGE UNIT
322 SGW FLOW MANAGEMENT TABLE
330 TRANSFER PATH ESTABLISHMENT PROCESSING UNIT
340 PACKET TRANSCEIVER UNIT
40 MME
400 CONTROL UNIT
410 TRANSCEIVER UNIT
420 STORAGE UNIT
422 MME FLOW MANAGEMENT TABLE
424 UE CAPABILITY INFORMATION MANAGEMENT TABLE
430 TRANSFER PATH ESTABLISHMENT PROCESSING UNIT
440 PACKET TRANSCEIVER UNIT
50 SGSN
500 CONTROL UNIT
510 TRANSCEIVER UNIT
520 STORAGE UNIT
522 SGSN FLOW MANAGEMENT TABLE
530 TRANSFER PATH ESTABLISHMENT PROCESSING UNIT
540 PACKET TRANSCEIVER UNIT
60 eNB
600 CONTROL UNIT
610 WIRED TRANSCEIVER UNIT
615 WIRELESS TRANSCEIVER UNIT
620 STORAGE UNIT
622 eNB FLOW MANAGEMENT TABLE
630 TRANSFER PATH ESTABLISHMENT PROCESSING UNIT
640 PACKET TRANSCEIVER UNIT
70 NB
700 CONTROL UNIT
710 WIRED TRANSCEIVER UNIT
715 WIRELESS TRANSCEIVER UNIT
720 STORAGE UNIT
722 NB FLOW MANAGEMENT TABLE
730 TRANSFER PATH ESTABLISHMENT PROCESSING UNIT
740 PACKET TRANSCEIVER UNIT
80 AR
800 CONTROL UNIT
810 WIRED TRANSCEIVER UNIT
815 WIRELESS TRANSCEIVER UNIT
820 STORAGE UNIT
822 AR FLOW MANAGEMENT TABLE
830 TRANSFER PATH ESTABLISHMENT PROCESSING UNIT
832 AR FLOW MANAGEMENT TABLE
840 PACKET TRANSCEIVER UNIT

1. A mobile communication system in which a first access network and a second access network are connected to a core network, and a first base station included in the first access network initiatively performs a handover of a mobile station connected to the first base station, from the first base station to a second base station included in the second access network, with respect to communication including a plurality of flows,
wherein the mobile station establishes a transfer path through a control station included in the core network and the first access network,
wherein the second base station determines an availability of a handover for each flow, and notifies the first base station of the determined availability of handover,
wherein the first base station establishes a transfer path to the second base station, and transmits a flow for which the handover is determined to be possible,
wherein the second base station transmits the transmitted flow to the mobile station, and
wherein the mobile station receives the transmitted flow from the second base station.

2. A first base station of a mobile communication system in which a first access network and a second access network are connected to a core network, and the first base station included in the first access network initiatively performs a handover of a mobile station connected to the first base station, from the first base station to a second base station included in the second access network, with respect to communication including a plurality of flows,
wherein in a case of performing the handover of the mobile station establishing a transfer path through a control station included in the core network and the first access network, the first base station establishes a transfer path to the second base station, and transmits a flow for which the handover is determined to be possible, based on a determination result of an availability of the handover for each flow notified from the second base station.

3. A mobile station of a mobile communication system in which a first access network and a second access network are connected to a core network, a first base station included in the first access network initiatively performs a handover of a mobile station connected to the first base station, from the first base station to a second base station included in the second access network, with respect to communication including a plurality of flows,
wherein the mobile station
establishes a transfer path through a control station included in the core network and the first access network, and
receives from the second base station, a flow which is transmitted from the first base station and for which a handover is determined to be possible, based on a determination result of an availability of the handover for each flow notified from the second base station.

4. The mobile station according to claim 3,
wherein a third access network is further connected to the core network, and
wherein the mobile station establishes a transfer path over the third access network and switches communication of flows other than the flow received from the second base station, from the transfer path through the third access network.

5. A communication method of a mobile communication system in which a first access network and a second access network are connected to a core network, and a first base station included in the first access network initiatively performs a handover of a mobile station connected to the first base station, from the first base station to a second base station included in the second access network, with respect to communication including a plurality of flows, the communication method comprising:
a step of establishing, by the mobile station, a transfer path through a control station included in the core network and the first access network,
a step of determining, by the second base station, an availability of a handover for each flow,
a step of notifying, by the second base station, the first base station of the determined availability of handover,
a step of establishing, by the first base station, a transfer path to the second base station, and transmitting a flow for which the handover is determined to be possible,
a step of transmitting, by the second base station, the transmitted flow to the mobile station, and
a step of receiving, by the mobile station, the transmitted flow from the second base station.
